(19) United States
(12) Patent Application Publication
(10) Pub. No.: US 2003/0035120 A1
(43) Pub. Date: Feb. 20, 2003

(54) Multiple-interferometer device for wavelength measuring and locking

(76) Inventors: Christopher J. Myatt, Boulder, CO (US); Kurt R. Vogel, Boulder, CO (US); Tim Dinneen, Longmont, CO (US); Jason R. Ensher, Lafayette, CO (US)

Correspondence Address: WILSON SONSINI GOODRICH & ROSATI, 650 PAGE MILL ROAD, PALO ALTO, CA, 943041050

(21) Appl. No.: 10/120,903

(22) Filed: Apr. 10, 2002

Related U.S. Application Data
(60) Provisional application No. 60/312,502, filed on Aug. 14, 2001.
(60) Provisional application No. 60/328,164, filed on Oct. 8, 2001.

(51) Int. Cl. G01B 9/02

(52) U.S. Cl. 356/519

(57) ABSTRACT

The invention describes devices and methods for determining the wavelength of coherent optical radiation such as is emitted from a laser source. The apparatus is monolithic with no moving parts and consists of optical components that generate signal periodic in the optical frequency of the coherent radiation detected by the component. Each optical component generates a signal with a different period. Differences between the periods of the signals generated by the optical frequency-dependent optical components provides a means of measuring optical wavelengths over a range far exceeding the free spectral range limitations of conventional interferometers. The method of the present invention allows for measurement of optical frequency with an uncertainty of much less than the period of the optical frequency-dependent optical components forming the apparatus.

### REFERENCE TO RELATED APPLICATIONS

The present application claims the benefit of priority from U.S. Provisional Patent Application Ser. No. 60/312,502, filed Aug. 14, 2000, which is incorporated herein by reference in its entirety.

### BACKGROUND OF THE INVENTION

1. Field of the Invention

The present invention relates to wavelength measurement devices (e.g. wavelength meter, optical spectrum analyzer or optical channel monitor), instruments that map the wavelength of a tunable laser, and devices installed within a laser to monitor optical wavelength.

2. Description of the Related Art

Laser frequency monitoring and locking is an essential technology for the emerging telecommunications market and will be useful in a number of other technological fields in the future. In state-of-the-art telecommunications systems, each of a plurality of laser signal sources is tuned in frequency to a distinct channel, allowing a plurality of signals to be simultaneously transmitted down a single optical fiber. The communications channels are defined on a grid with equal frequency spacing in a band near 194 THz (ITU grid). Each telecommunication laser must be stabilized or monitored to ensure it remains tuned to the proper communications channel.

The high sensitivity of telecommunication components to wavelength deviations also requires that the test equipment possess a high wavelength accuracy and precision. Test lasers whose wavelength is swept to measure the wavelength dependence of a parameter require wavelength information at the picometer level. The associated devices that monitor optical components or network channels also require high accuracy. Measurement speed is extremely important for high sweep rates of optical wavelength, or monitoring of rapid changes in the optical wavelength (e.g due to noise). Finally, equipment must be compact so as to occupy minimal space and fit directly into existing devices (such as telecom laser packages) as well as portable or handheld instruments.

High speed and accuracy of wavelength measurement is essential to the monitoring and control of existing and next generation optical networks Minimizing downtime in optical networks is already an operational and economic necessity that requires constant care and monitoring of the optical wavelength and power of the communication channels. The need for monitoring will only increase as networks use tunable lasers to add network flexibility and responsiveness. Accurate, compact, rugged and inexpensive optical channel monitoring is imperative.

A simple form of wavelength monitoring is a system shown in FIG. 1. A first beamsplitter 2, positioned in a portion of a first optical beam 4 from a laser source, generates a second optical beam 6 that is detected by an optical power detector 8 to provide a power reference for the laser. A second beamsplitter 10, joined to first beamsplitter 2, reflects a third optical beam 12 of the first optical beam into a resonator 14. The light 16 transmitted through the resonator is detected by a second optical power detector 18. As illustrated in FIG. 2, resonator 14 may be a Fabry-Perot (FP) Interferometer (or etalon) whose optical transmission varies periodically with optical frequency, where the period is called the free spectral range 20 (FSR). FPs and etalons are excellent wavelength discriminators and references for optical sources whose optical frequency resides on the high slope region 22 of a transmission fringe. When the FSR of the resonator equals the frequency spacing of the ITU grid the device can be used as a monitor of optical communication channels, or as a wavelength locker. Such a monitoring device is ideal for telecommunications laser packages because the device is very compact and rugged. The response of the device, limited only by the photodiode and associated electronics, can provide very fast wavelength information.

Devices of FIG. 1 are only able to accurately measure the optical frequency of light modulo the FSR, for two reasons. The first limitation to accuracy is shown in FIG. 2: Each peak in optical transmission of the device is indistinguishable from the next. The second limitation to accuracy is that the measurement precision depends on the optical frequency. Again referring to FIG. 2, the measurement resolution of wavelength is a maximum on the high slope region 22 where the transmitted intensity varies rapidly with changing frequency. At the peaks and valleys of the transmission spectrum, the precision is greatly reduced because the signal changes very little as the optical frequency changes (e.g. low slope region 24). When the high slope region 22 is aligned with the ITU grid the wavelength measurement device provides sufficient precision to monitor and control a communications laser. If low slope region 24 is aligned with the grid, the device using a single FP interferometer cannot generate the necessary signals for laser control. Among other limitations, devices of FIG. 1 cannot identify specific ITU channels, adapt to revisions of the ITU channel spacing, or measure arbitrary wavelengths within the telecommunication bands.

Another way to monitor the frequency of the laser is to build a wavelength meter: a device that measures the wavelength of light independently of the ITU grid. A description of a sophisticated and very high precision wavelength measuring device is found in J. Hall et al (J. L. Hall and S. A. Lee, Applied Physics Letters, 29, 367 (1976)). A first disadvantage of this device is the very slow update rate due to the physical motion of the interferometer arm. A second disadvantage is the large size and lack of portability, which makes it impractical to include with each telecommunication laser, or even a laser in a test instrument. A third disadvantage is the cost and environmental sensitivity of the reference laser needed for high measurement accuracy.

The current needs of wavelength measurement in the telecommunication industry exceed the capabilities of the prior art. There is a need for picometer wavelength accuracy over the entire telecommunication bandwidth. There is a need for high speed measurement. There is a need for a robust, compact and inexpensive wavelength meter device for measurement of optical wavelength. There is a need for a single wavelength meter device with all these features.

### SUMMARY OF THE INVENTION

Accordingly, an object of the present invention is to provide a wavelength meter device capable of measuring one optical wavelength with an accuracy better than about 10 parts per million over a range of optical wavelengths greater than about 50 nm.

Another object of the invention is to provide a rugged, compact and relatively inexpensive wavelength meter device.

Another object of the invention is to provide a wavelength meter device with measurement rates much faster that 10 per second.

A further object of the invention is to provide a wavelength meter device that measures more than one optical wavelength in an optical beam.

A further object of the invention is to provice a optical spectrum analyzer device capable of measuring an optical spectrum of an optical beam with more than one optical wavelength.

### BRIEF DESCRIPTION OF THE DRAWINGS

FIG. 1 is a schematic of a single-etalon wavelength measurement scheme in the prior art.

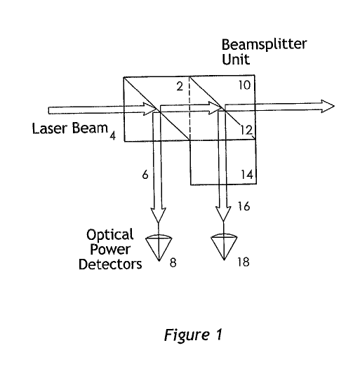

FIG. 2 is an optical transmission spectrum of a Fabry-Perot Interferometer showing wavelength periodicity and the Free Spectral Range (FSR).

FIG. 3a is a schematic of an wavelength meter device including partial reflectors, positioned serially in at least part of an optical beam from an optical source.

FIG. 3b is a schematic of the wavelength meter device including partial reflectors, positioned in series and in parallel in at least part of an optical beam from an optical source.

FIG. 3c is a schematic of the optical wavelength meter device including a grouping of optical components positioned without partial reflectors in at least part of an optical beam from an optical source.

FIG. 4a shows an optical component, of a wavelength meter device made of an interferometric optical element (IOE) and optical power detector (OPD).

FIG. 4b shows an optical power spectrum of an optical beam input to the IOE.

FIG. 4c shows an optical power spectrum of an optical beam transmitted by the IOE.

FIG. 5a shows an optical component, of a wavelength meter device made of an IOE and a photodiode.

FIG. 5b illustrates a plurality of IOEs and an array of photodiodes.

FIG. 5c illustrates a plurality of IOEs and a multi-segment photodiode.

FIG. 6a shows an OPD including photodiode and optical integrating sphere.

FIG. 6b shows an OPD including photodiode and substantially hollow optical integrating sphere.

FIG. 6c shows an OPD including photodiode and substantially solid optical integrating sphere.

FIG. 7 shows a wavelength meter device including partial reflectors (PRᵢ), etalons (Eᵢ), OPDs and a signal processor.

FIG. 8 shows a typical optical transmission of a three-etalon wavelength meter device with differential path lengths in each etalon.

FIG. 9 illustrates an algorithm for determination of optical frequency of an optical beam in a wavelength meter device.

FIG. 10 shows an air-spaced etalon including two optical elements, each with partial reflectivity coatings separated by a spacer.

FIG. 11 shows a wavelength meter device including three air-spaced etalons formed of thin film layers deposited on a single optical surface.

FIG. 12 shows a wavelength meter device including three air-spaced etalons formed of two equal-thickness thin film layers deposited on two optical surfaces.

FIG. 13 shows a wavelength meter device including partial reflectors (PRᵢ), solid etalons (SEᵢ), OPDs and signal processor.

FIG. 14 shows a wavelength meter device including partial reflectors (PRᵢ), electro-optic elements (EOEᵢ), OPDs and signal processor.

FIG. 15 shows prior art of an optical component including a birefringent element and a polarizer.

FIG. 16 shows a waveguide resonator with optical tap grating.

FIG. 17 shows a wavelength meter device including three waveguide resonator planes.

FIG. 18 shows a wavelength meter device including three waveguide resonators, optical tap gratings and detectors on a single planar substrate.

FIG. 19 shows a wavelength meter device including a 1×3 waveguide splitter coupling to three waveguide resonators.

FIG. 20 shows a wavelength meter device including a polarization controller (PC).

FIG. 21 shows a wavelength meter device including a polarization scrambler (PS).

FIG. 22 illustrates a wavelength locking device including, a wavelength meter device made of optical components (OCᵢ) and a coupler coupling optical frequency readout to an optical source.

FIG. 23 illustrates a wavelength locking device including, a wavelength meter device made of etalons (Eᵢ) and a coupler coupling optical frequency readout to an optical source.

FIG. 24 illustrates a wavelength locking device including, a wavelength meter device made of air-spaced etalons (ASEᵢ) and a coupler coupling optical frequency readout to an optical source.

FIG. 25 illustrates a wavelength locking device including, a wavelength meter device made of solid etalons (SEᵢ) and a coupler coupling optical frequency readout to an optical source.

FIG. 26 illustrates a wavelength locking device including, a wavelength meter device made of electro-optic elements (EOEᵢ) and a coupler coupling optical frequency readout to an optical source.

FIG. 27 illustrates a wavelength locking device including, a wavelength meter device made of polarization controller (PC) and air-spaced etalons (ASEᵢ); and a coupler coupling optical frequency readout to an optical source.

FIG. 28 illustrates a wavelength locking device including, a wavelength meter device made of polarization scrambler (PS) and air-spaced etalons (ASEᵢ); and a coupler coupling optical frequency readout to an optical source.

FIG. 29 shows a wavelength meter device including a tunable optical filter element (TOFE).

FIG. 30 is a schematic of a multi-wavelength measurement scheme.

FIG. 31 is an algorithm for determination of more than one optical frequency in an optical beam in a wavelength meter device.

FIG. 32 shows a wavelength meter device including a tunable optical filter element (TOFE) and an optical power detector (OPD).

FIG. 33 is an algorithm for determination of the optical frequency spectrum of an optical beam in a wavelength meter device.

FIG. 34 shows a wavelength meter device including a polarization controller (PC) and tunable optical filter element (TOFE).

FIG. 35 shows a wavelength meter device including a polarization scrambler (PS) and tunable optical filter element (TOFE).

FIG. 36 shows a wavelength locking device including a multiple-wavelength meter device and a coupler coupling optical frequency readouts to optical sources.

FIG. 37 shows a wavelength locking device including a polarization-mitigated multiple wavelength meter device and a coupler coupling optical frequency readouts to optical sources.

FIG. 38 shows a wavelength meter device including an optical power detector (OPD) and optical components (OCᵢ).

FIG. 39 shows a wavelength meter device using air-gapped etalons, formed of a reflection coated monolithic beam splitter and a pattern coated substrate.

FIG. 40 shows a wavelength meter device using an air-spaced etalon made from two optical elements.

FIG. 41 shows a wavelength meter device using an air-spaced etalon made from two optical elements each having a thin film coating.

FIG. 42 shows a wavelength meter device including an optical power detector (OPDO) and solid etalons (SEᵢ).

FIG. 43 shows a wavelength meter device including 1×4 beamsplitter, optical power detector and solid etalons.

FIG. 44 shows a wavelength meter device including an optical power detector and electro-optic elements (EOEᵢ)

FIG. 45 shows a polarization-insensitive wavelength meter device including three solid etalons joined to a fourth component with a clearance hole.

FIG. 46 shows a polarization-insensitive wavelength meter device including three solid etalons joined in an L-shaped profile.

FIG. 47 shows a polarization-insensitive wavelength meter device including optics for asymmetric expansion of an input optical beam.

FIG. 48 shows a wavelength locking device including a wavelength meter device made of an optical power detector (OPD) and optical components (OCᵢ); and a coupler coupling optical frequency readout to an optical source.

FIG. 49 shows a wavelength locking device including a wavelength meter device made of an optical power detector (OPDhd 1) and etalons (Eᵢ); and a coupler coupling optical frequency readout to an optical source.

FIG. 50 shows a wavelength locking device including a wavelength meter device made of an optical power detectors (OPD₁) and air-spaced etalons (ASEᵢ); and a coupler coupling optical frequency readout to an optical source.

FIG. 51 shows a wavelength locking device including a wavelength meter device made of an optical power detector (OPD₀) and solid etalons (SEᵢ); and a coupler coupling optical frequency readout to an optical source.

### DETAILED DESCRIPTION OF PREFERRED EMBODIMENTS

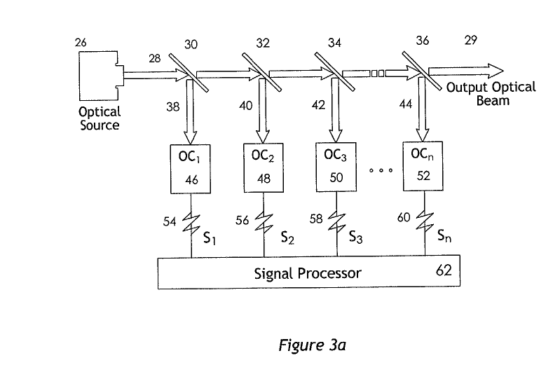

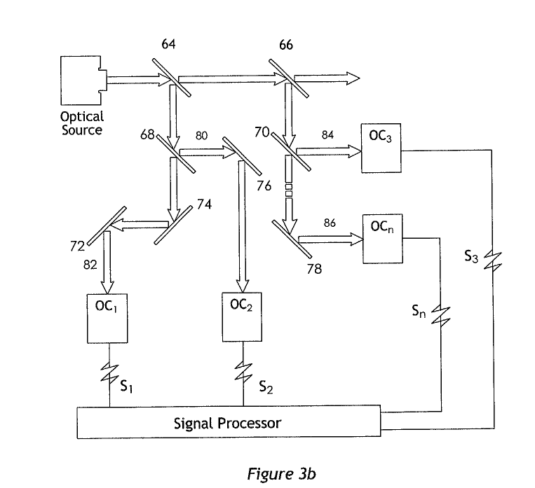

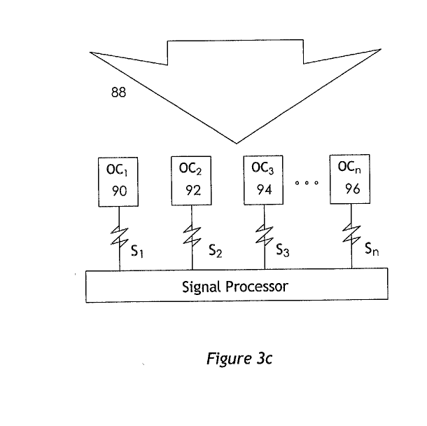

Various embodiments of the present invention are illustrated by FIGS. 3a-3c. Referring now to FIG. 3a, optical source 26 generates an optical beam 28 that is received by wavelength meter device 29. A plurality of partial reflectors 30, 32, 34 and 36 are positioned serially and at least partially in optical beam 28. Partial reflectors 30, 32, 34 and 36 produce optical beams 38, 40, 42, and 44. Optical components 46, 48, 50 and 52 receive optical beams 38, 40, 42 and 44 and generate signals 54, 56, 58 and 60. Each signal is periodic in the optical frequency of the light detected by each optical component. Signals 54, 56, 58 and 60 couple to signal processor 62. Signal processor 62 implements an algorithm, detailed below, which calculates the optical frequency of optical beam 28. A similar embodiment is shown in FIG. 3b, wherein partial reflectors 64, 66, 68 and 70 and mirrors 72, 74, 76 and 78 generate optical beams 80, 82, 84 and 86 that are detected by the optical components. FIG. 3c illustrates a third embodiment. Optical beam 88 is incident on optical components 90, 92, 94 and 96 that are positioned at least partially in optical beam 88 without additional partial reflectors or mirrors. Optical beam 88 may be prepared by expanding it with a magnifying, collimation optic or other suitable optics.

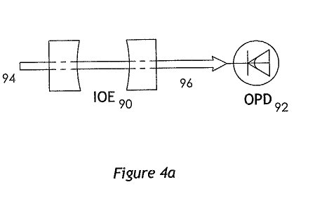

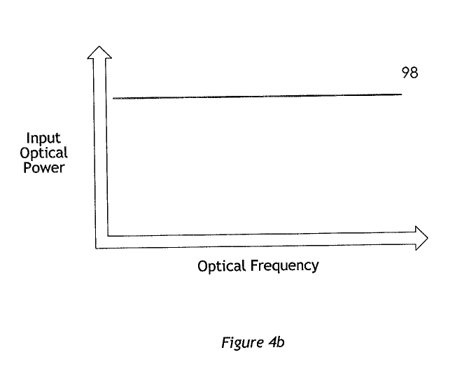

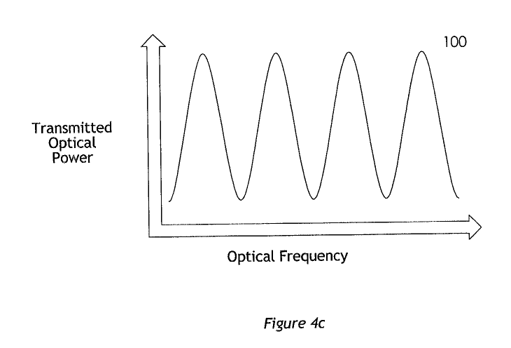

As shown in FIGS. 4a, optical components in the above embodiments may consist of an interferometric optical element 90 (IOE) and optical power detector 92 (OPD). A portion of an optical beam 94 enters IOE 90. IOE 90 generates optical beam 96, which is detected on OPD 92. As shown in FIG. 4b, optical beam 94 has a nominally flat dependence 98 of optical power on the optical frequency. As illustrated in FIG. 4c, optical beam 96 has a periodic dependence 100 of transmitted optical power on optical frequency.

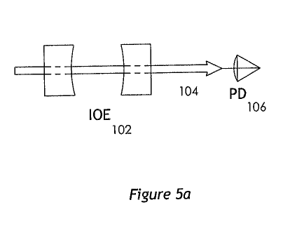

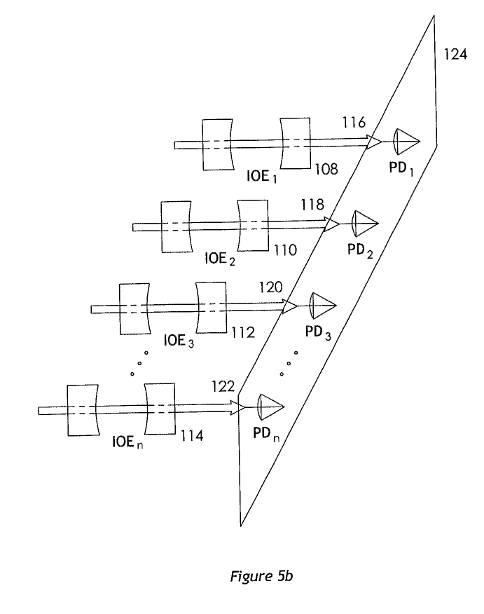

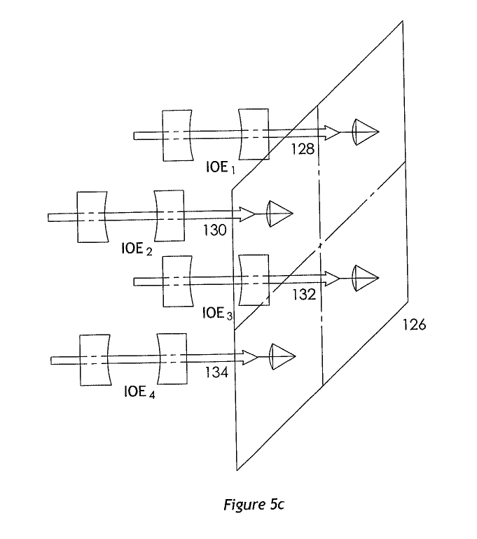

OPD 92 may include any number of optical-to-electrical converters, including but not limited to photodiodes, avalanche photodiodes, PMTs and the like. FIG. 5a illustrates one embodiment of a single IOE 102 producing an IOE beam 104 detected by a single photodiode (PD) 106. Referring to FIG. 5b, another scheme is to use an array of photodiodes, such that a plurality of IOEs 108, 110, 112 and 114 generate a plurality IOE beams 116, 118, 120 and 122, and the IOE beams are detected on a photodiode array 124. Similarly, FIG. 5c shows a quadrant photodiode, hybrid CCD array or similar multi-segrnent photodiode 126, which detects IOE beams 128, 130, 132 and 134.

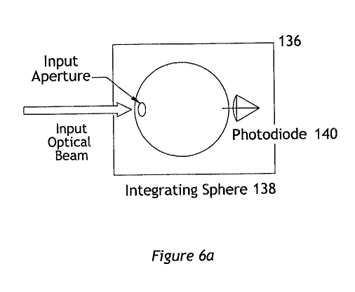

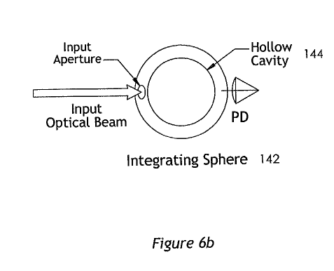

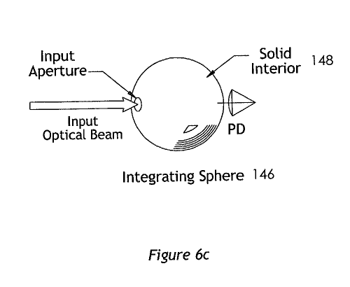

A concern with OPD 92 is the sensitivity to the state of polarization of the detected light. As shown in FIG. 6a, various embodiments of an optical power detector 136 include an integrating sphere 138 to mitigate polarization sensitivity, as well as to increase the maximum light level that may be detected on photodiode 140 prior to saturation of the photodiode output. As illustrated in FIG. 6b, integrating sphere 142 may include a hollow cavity 144. As illustrated in FIG. 6c, integrating sphere 146 may include a solid interior 148.

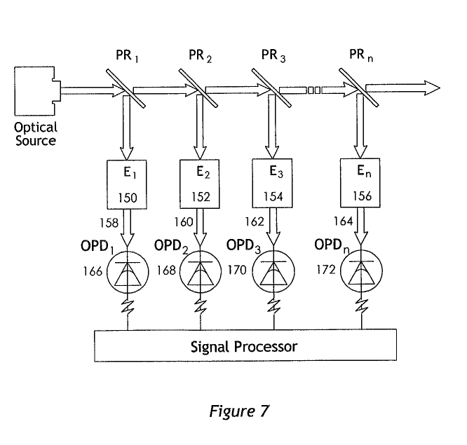

Referring to FIG. 7, one embodiment of a wavelength meter device 29 uses etalons and optical power detectors in place of optical components 38, 40, 42 and 44. Etalon refers to a device made of two surfaces separated to form a resonant cavity for light, each surface coated with metal, dielectric or other layer to provide partial reflectivity. Etalons 150, 152, 154 and 156 generate etalon optical beams 158, 160, 162 and 164 relative to the optical frequency of the first optical beam 28, and the finesse and FSR of each etalon. Each etalon optical beam is detected by optical power detectors (OPD₁, OPD₂, OPD₃. . . OPDₙ) 166, 168, 170 and 172. Optical power detectors generate signals 54, 56, 58, 60. Signal processor 62 reduces the signals, via the algorithm explained below, to an optical frequency with uncertainty of less than the FSR of the etalons.

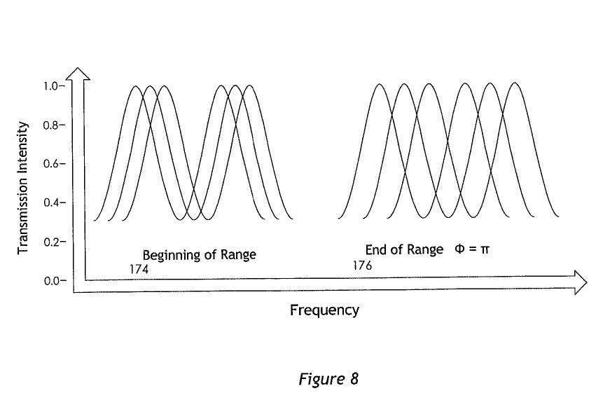

The FSR of the etalons and the difference in FSR between the plurality of etalons is chosen such that, at any optical frequency within the measurement range, the relative transmission orders of the etalons remains unchanged, although the absolute order of transmission of each etalon may be different. The result is a device that exhibits a progression in the transmission characteristics over the range of operation. At the beginning of the optical frequency range 174, the transmission peaks for the etalons cluster together (which we refer to as the cluster frequency). At the end of range 176 of optical frequencies, the transmission peaks for the etalons are separated. The difference in optical phase between the etalons is 0<φ<π (modulo π) over the measurement range. Mathematically this is not the only ordering of the optical phase of the transmission signals. For example, π<φ<2π also satisfies the operational requirements for the device (the clustering of the transmission signals has a different characteristic to that shown in FIG. 8). Each measurement of optical frequency requires a set of three optical power signals with a unique relationship between the optical path lengths that identifies the exact transmission order of the etalons leading to a unique and precise measurement of the optical frequency.

In order to use the three or more optical power signals, wavelength meter device 29 removes variations in the signals due to variations in the optical power of the optical source 26. In various embodiments of wavelength meter device 29, only signals 54, 56, 58 and 60 periodic in optical frequency are generated by wavelength meter device 29. Wavelength meter device 29 does not measure the optical power of optical source 26. Signals 54, 56, 58 and 60 may be normalized by a signal external to wavelength meter device 29 that is proportional to the optical power of optical beam 28. Information about the optical power of optical beam 28 may be already available from optical source 26 (e.g., from the power setting or from a power meter elsewhere in the system). Correct normalization of signal 54, 56, 58 and 60, to the same reference signal level requires accounting for insertion losses and reflection ratios along each path to optical components 46, 48, 50 and 52. Embodiments without internal optical power measurement have the advantage of fewer components, simpler construction, and lower overall cost.

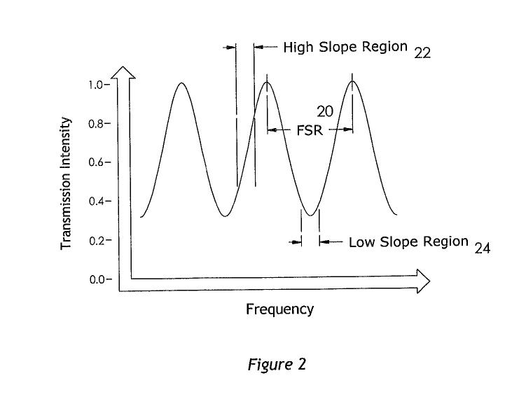

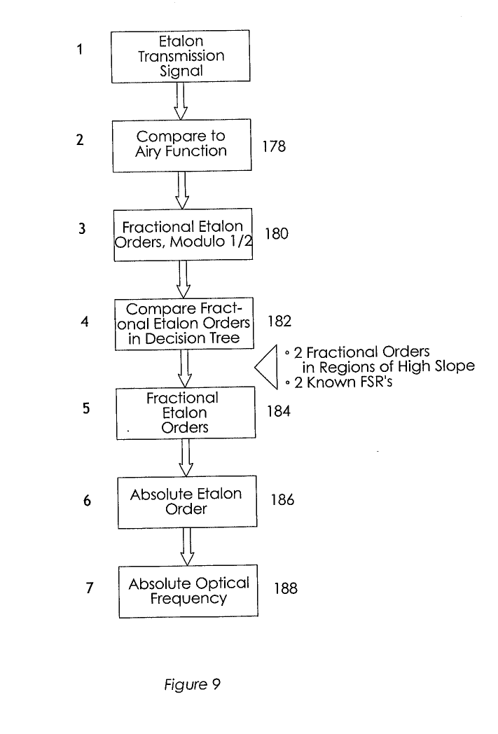

Once signals 54, 56, 58 and 60 are normalized, a method illustrated in FIG. 9 uniquely determines the optical frequency of an optical source. In the discussion below we employ the focus on the case of a wavelength meter device 29 consisting of optical components made of IOE 90 and OPD 92. For clarity, we refer to IOEs as etalons although generally the IOE may be some form of interferometric device such as a Michelson or Mach-Zehnder Interferometer. The analysis is presented in the frequency domain. An optical frequency can be expressed as (n+e)*FSR, where n represents the integer etalon order of transmission and e represents a fractional etalon order based on the relationship between transmission and frequency as shown in FIG. 2. With a single etalon, n is not known but the fractional order e can be measured very precisely if it occurs in high slope region 22 of FIG. 2. In a wavelength meter device 29 consisting of only three etalons, where each etalon has a different FSR, three different expressions for the optical frequency can be written for the three etalons. The fractional order e can be computed with high accuracy for each etalon based on an initial calibration of the etalon finesse and FSR (2nd Step 178 and 3rd Step 180). For the invention described here, the FSR of the etalons have a relationship that enables identification of the integer orders from a measurement of the three fractional orders.

For a single etalon, the difference between two frequencies is written

ƒ−ƒ₀=(n−n₀+e−e₀)*FSR

where ƒ is the unknown frequency, n is the etalon order and e is the fractional etalon order. The fractional etalon order is a number between 0 and 1 and resolves the unknown frequency to a fraction of the FSR. In the wavelength meter device 29, although n and n₀ may be different for each etalon, the etalons are constructed so that the etalon order difference n-n₀ is the same for every etalon. As described lo below, the fractional order is measured for each etalon. A calibration of the reference frequency ƒ₀ provides the etalon orders n₀ and e₀. Thus, the expression for frequency, in terms of a single etalon, reduces to a single equation in two unknowns, m and ƒ:

ƒ−ƒf₀=(m+e−e₀)*FSR

where m is the etalon order difference common to all of the etalons. Taken together with a similar expression for either of the remaining two etalons we have a system of two equations in two unknowns, from which m and ƒ are calculated. The three-etalon scheme described here ensures that the frequency ƒ is in the high slope region of the transmission spectra of at least two etalons, which provides the resolution to determine the order difference m and the frequency ƒ.

The fractional etalon order is determined by comparing the etalon transmission signal to the Airy transmission function, and by use of a decision tree (4^{th} Step 182 and 5^{th} Step 184). By comparing the normalized transmission signal versus the theoretical transmission curve, the location of the unknown frequency may be found modulo an uncertainty of one-half of a FSR. The uncertainty arises because the transmission function is periodic. Thus, for a time-independent transmission signal through one etalon it is not possible to locate which side of a transmission peak the signal comes from. Fortunately, since a known ordering exists between the etalons in this invention, the side of the peak from which the signal arises for each etalon can be resolved with a decision tree. In the decision tree, a FSR for one etalon is partitioned according to the set of fractional etalon orders of all three etalons. For example, FIG. 8 illustrates how the ambiguity in the middle etalon is resolved by comparing the magnitudes of the signals from the other two etalons. A similar pattern of logic and concomitant self-consistency uniquely identifies the fractional order for each etalon.

Once the algorithm deduces the fractional etalon order for each of the etalons, the algorithm can obtain the common etalon order (6^{th} Step 186). In principle, the frequency equations of the three etalons over-determine the solution for our two unknowns, m and ƒ. In practice, a transmission signal for one of the etalons comes from a peak or valley. The lack of slope near the extrema renders the calculation of the fractional order useless for that etalon. Because the FSRs differ, the transmission signals for the remaining two etalons will occur in regions of high slope (and hence, high accuracy). The problem reduces to two equations from which the etalon order difference and optical frequency are found (7^{th} Step 188).

The choice of the difference in the FSRs of the etalons in wavelength meter device 29 is an important aspect of the present invention. The size of the FSR difference determines the frequency range for accurate measurement of the frequency. The effect may be understood as a breakdown of the validity of the decision tree. At or near the cluster frequency, there is no measurable difference between transmission signals and no means to determine the fractional etalon orders. The cluster frequency defines the low-end of the optical frequency measurement range. As optical frequency increases, the spacing of the etalon transmission signals increase by one FSR difference for each etalon order. The decision tree resolves the fractional etalon orders. The signals also generally occur in regions of high slope such that the fractional etalon order may be known to high precision. Ultimately, when the frequency increases enough that the etalon transmission signals are 180 degrees out of phase, the decision tree is unable to resolve the ambiguity in fractional etalon order. The optical frequency when this occurs defines the high-end of the optical frequency measurement range. The present invention extends the measurement range of the wavelength meter device by suggesting devices of three or more etalons, which increases the range of optical frequencies by insuring at least two etalons exhibit transmission in the high slope regions everywhere in the measurement region.

The length differences between etalons are at the scale of the wavelength of the light with the exact length dependent on the measurement range desired. In one embodiment, the path length differences are identical. In this case, the optical phase difference between any two etalons may be kept below π if and only if the length difference between etalons are odd multiples of one-sixteenth of the central wavelength of the measurement range (defined as the midpoint between the wavelength at the cluster frequency, and the wavelength at an optical path length difference of π between the shortest and longest etalon). The invention is not fundamentally changed by choosing non-identical path length differences, but rather the details of the algorithm for calculating optical frequency are more complicated. In the three-etalon device, the reflectivity of the etalons is optimally near 0.25, which implies a finesse of about 2.

Returning now to an embodiment of a wavelength meter device of three etalons, the following parameters are typical. For the desired part per million (ppm) precision, over a frequency range of about 6 THz or more, the FSR will typically be on the order of 100-200 GHz. The actual FSR depends on the signal-noise ratio (SNR) and the operation speed or bandwidth. Since the measurement is a two-step process, first determining the partial etalon order and then the integer etalon order, a 1 ppm resolution requires each step to attain a resolution of approximately one part per thousand. For example, over the optical telecommunication frequencies in the C and L-bands (15 THz) this implies a FSR near 200 GHz.

For devices employing larger numbers of etalons, the reflectivity may be substantially higher and the precision of the wavelength meter device may be greatly increased. Using high reflectivity is an advantage because it increases the precision of the optical frequency measurement. On the other hand, the larger the reflectivity, the smaller are the regions of optical frequency over which the etalon's transmission spectrum has high slope. By adding additional etalons of larger or smaller optical path length, the range of optical frequencies covered by at least two etalons with high slope is increased. Therefore, using more than three etalons with finesse greater than 2 can obtain even higher precision in the optical frequency measurement than achieved with only three etalons, yet operate over a similar range of optical frequencies.

The previous language of etalons, explaining the constraints on etalons in the wavelength meter device, is readily generalized to optical components that generate signal periodic in optical frequency. The FSR is merely the period of the optical transmission (or reflection) generated by an etalon. The above discussion also obtains for optical components that generate signal periodic in the optical frequency, simply by replacing “FSR” with “period of the signal generated by the optical component”. When the etalon discussion refers to different optical path lengths, a more general device requires optical components with different periods in the generated signals. Although the concept of reflectivity is not directly transferable, the finesse does transfer since it is defined as the ratio of signal period to half-width at half maximum of the periodic features.

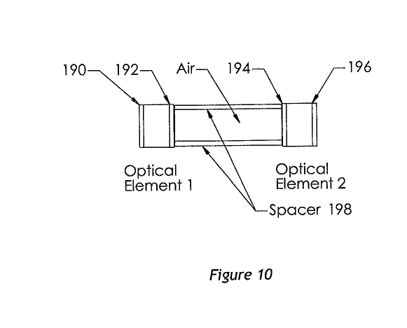

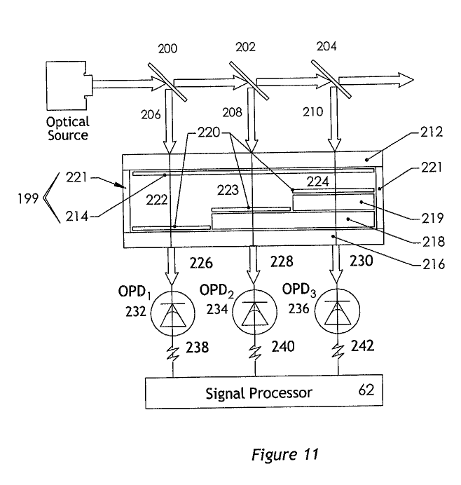

In various embodiments of a wavelength meter device 29, the device may be constructed as a single unit using optical contacting techniques. Partial reflectors 30, 32, 34 and 36 may take the form of a single, monolithic beamsplitter such as a 1 by 4 beamsplitter optic with 45 degree reflectors. As shown in FIG. 10, IOEs 90 may be air-spaced etalons wherein two surfaces, coated with partial reflectivity coatings 190, 192, 194 and 196 are separated by spacer 198. The air-spaced etalons may be constructed in a variety of configurations. Referring to FIG. 11, three air-spaced etalons 199 may be constructed in a monolithic architecture in which first optical beam 28 is partitioned by partial reflectors 200, 202 and 204 into optical beams 206, 208 and 210. Optical beams 206, 208 and 210 enter three air-spaced etalons 199 made from a first optical element 212 with partial reflectivity coating 214; a second optical flat 216 with a two-layer thin-film pattern coating (layers 218 and 219) and partial reflectivity coating 220; and a spacer 221 creating three air gaps 222, 223, 224 of different lengths between optical elements 212 and 216. Coatings 218 and 220 may consist of a material similar to the material of optical elements 212 and 216, but in general may be made of a non-identical material. Coating 220 covers about ⅓ of the surface area of element 216, and coating 218 covers about ⅔ of the surface area of element 216 such that the three regions of optical path length occupy about equal areas of optical elements 212 and 216. Etalon optical beams 226, 228 and 230, generated relative to the optical frequency of first optical beam 28, the reflectivities of coatings 214 and 222, and the optical path lengths, are detected by optical power detectors (OPDs) 232, 234 and 236. The three OPDs generate signals 238, 240 and 242 that couple to signal processor 62 that employs the algorithm of FIG. 9 to determine the optical frequency.

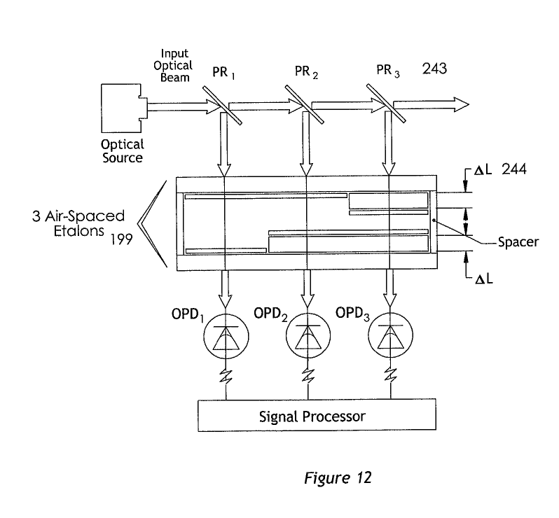

FIG. 12 illustrates wavelength meter 243 in which three etalons are formed from a single run of thin film pattern-coating applied to first and second optical elements 212 and 216. Thin film coating 219 covers about ⅓ of the surface area of optical element 212, while the coating 218 covers about ⅔ of the surface area of optical element 216. Partial reflectivity coatings 214 and 222 cover the patterncoated optical elements 212 and 216. Overlapping the pattern-coated flats creates three different etalons with substantially equal path-length difference ΔL 244. The path-length differences in the three air-spaced etalons 199 are very uniform because the uniformity of coating thickness is much better in a single run of coating than between multiple coating runs.

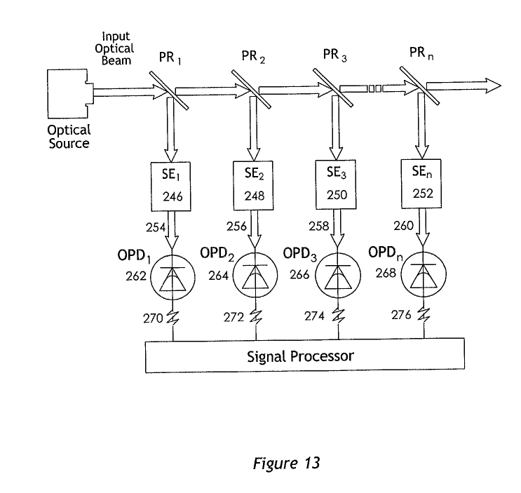

In another embodiment of the wavelength meter device, the etalons are made of solid material with polished end surfaces and partial reflectivity coatings. As before, first optical beam 28 is partitioned by a plurality of partial reflectors (PRs) 30, 32, 34 and 36 that generate optical beams 38, 40, 42 and 44. Referring now to FIG. 13, the optical beam interact with solid etalons (SEs) 246, 248, 250 and 252. The solid etalons generate optical beams 254, 256, 258 and 260 relative to the frequency of first optical beam 28, and the length of and optical coating on the SEs. The optical beams are detected by optical power detectors (OPDs) 262, 264, 266 and 268. A plurality of signals 270, 272, 274 and 276, which are generated by the OPDs, couple to signal processor 62 that implements the optical frequency measurement algorithm of FIG. 9.

The calculation of the measurement algorithm of FIG. 9 is performed in signal processor 29, which includes but is not limited to a digital signal processor (DSP). The calculation may be refined to account for wavelength dependencies of partial reflectors 30, 32, 34, 36 (and 64, 66, 68 and 70) and OPDs 92. Accounting for wavelength dependencies of components may require a second iteration of the calculation. The wavelength dependencies are small by the very design of the monolithic structure as in three air-spaced etalons 199 and the first pass calculation provides a very good value for the wavelength that, in many applications, will be sufficient. Within the scheme of the algorithm of FIG. 9, the initial value for the optical wavelength provides the appropriate correction factors from an initial calibration lookup table or parameterized equation.

The facility of signal processor 62 to perform successive approximations and computations also allows an alternative embodiment of wavelength meter device 29 consisting of solid etalons 246, 248, 250 and 252. The algorithm of FIG. 9 must be augmented to account for the temperature dependence and dispersion properties of the solid etalons in the determination of the optical wavelength. A simple and effective calculation method is to store information on the wavelength and temperature dependencies of the glass in the form of a lookup table in signal processor 62. Iterative calculation then corrects for wavelength and temperature dependence through calculation of successive approximations

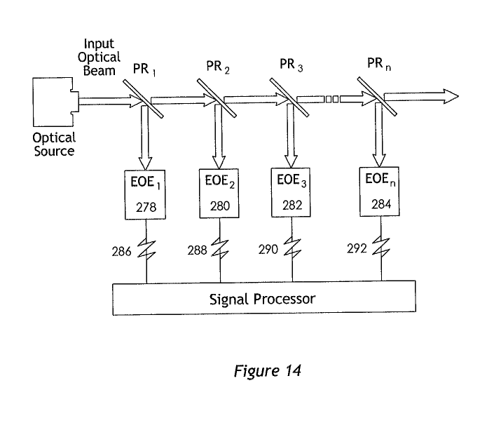

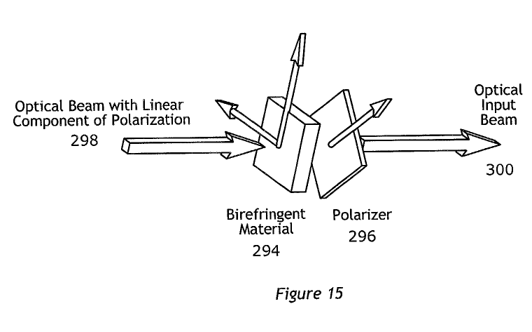

The flexible computation capabilities of signal processor 62 also allows use of very general electro-optic components in wavelength meter device 29. A power signal processor 62 maybe required to make general corrections for temperature, wavelength and other systematics in the signals from electro-optic components. As shown in FIG. 14, the wavelength meter device 29 may be constructed from a plurality of electro-optic elements (EOEs) 278, 280, 282 and 284 that generate signals 286, 288, 290 and 292 periodic in the optical frequency of first optical beam 28. As shown in the prior art of FIG. 15, an EOE might consist of a birefringent material 294 and polarizer 296. For an optical beam with a linear state of polarization 298, birefringent medium 294 creates a rotation in the state of polarization. The rotation depends on the phase shift of light in birefringent medium 294; the phase shift is periodic in the optical frequency. Polarizer 296 transforms the periodicity in phase shift into an amplitude modulation of output optical beam 300 that is periodic in optical frequency.

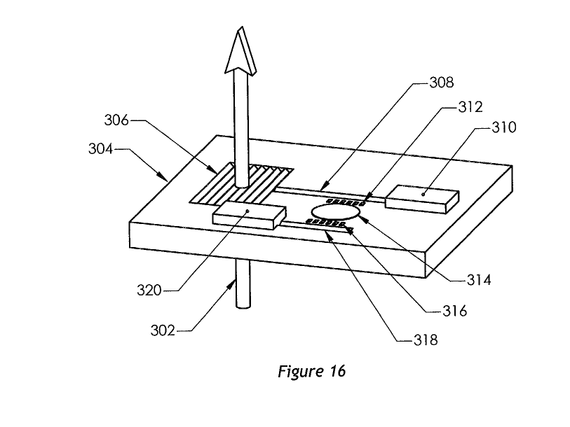

Another class of possible EOEs for use in a wavelength meter device are waveguide resonators. Referring to FIG. 16, a first optical beam 302 enters a planar substrate 304 consisting of an optical tap grating 306 that couples a small fraction of optical beam 302 into a waveguide 308. Tap grating 306 has a period of one-half the wavelength of first optical beam 302 to generate a diffracted optical beam along the surface of the substrate and into the waveguide 308. Optical power coupled into waveguide 308 is detected by optical power detector 310. A second tap grating 312 couples light from waveguide 308 into waveguide resonator 314. A third tap grating 316 couples light in resonator 314 into waveguide 318 where it is detected by optical power detector 320. The ratio of the difference to the sum of signals from detectors 310 and 320 is a normalized signal that is periodic in optical wavelength.

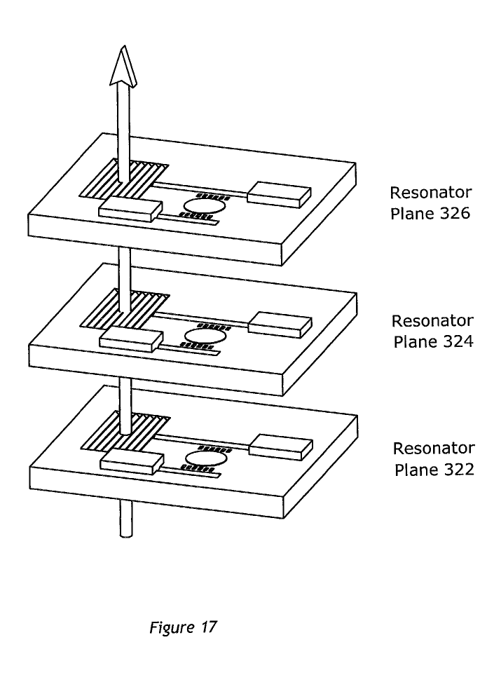

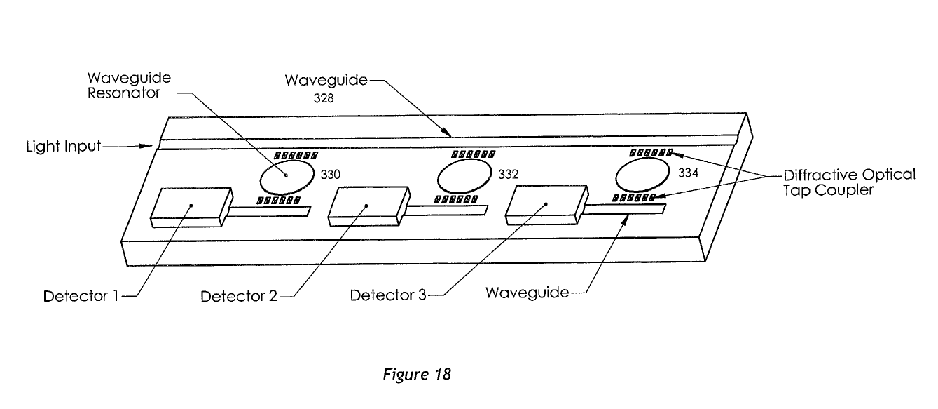

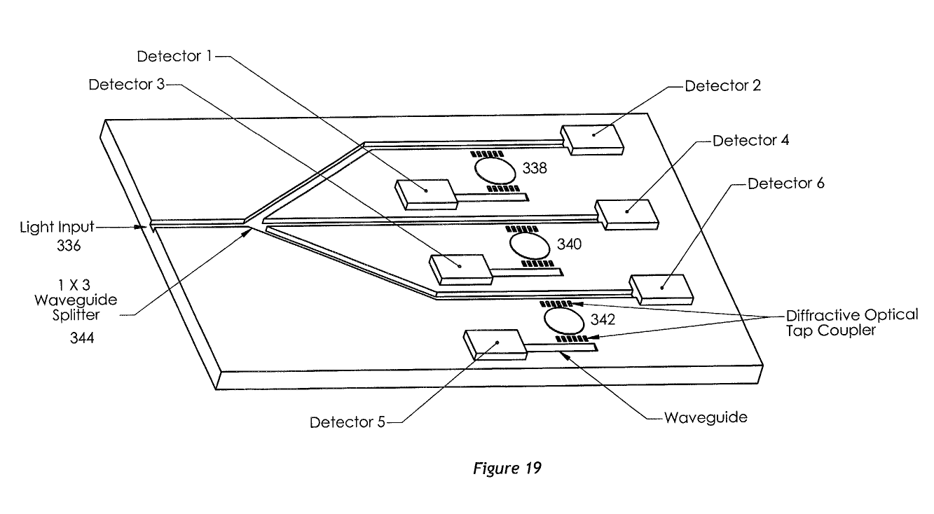

A wavelength meter device may be formed from several combinations of the waveguide resonator EOEs. A first embodiment consists of a plurality of resonator planes 322, 324 and 326 stacked as illustrated in FIG. 17. As shown in FIG. 18, a second embodiment consists of tapping a single waveguide 328 with a plurality of waveguide resonators 330, 332 and 334 in series on a single substrate. As shown in FIG. 19, a third embodiment consists of dividing a light input 336 among a plurality of waveguide resonators 338, 340 and 342 by a waveguide beamsplitter 344.

For various embodiments of a wavelength meter device 29 device of the present invention, an accurate measurement of wavelength require an accurate initial calibration of the optical components 46, 48, 50 and 52. For instance, one objective of the calibration is to provide accurate values for the FSR's of each SE 246, 248, 250 and 252 along with an absolute wavelength reference. A second objective of initial calibration is to provide an accurate description of the finesse (transmission line shape) of each SE so that signals 270, 272, 274 and 276 may be interpreted accurately as partial orders of transmission of the respective etalons. A third objective of the calibration is to provide information on wavelength dependencies of partial reflectors 30, 32, 34 and 36 and detectors 262, 264, 266 and 268. If solid etalons are used as in optical components 46, 48, 50 and 52, a fourth objective of the calibration is to measure the wavelength dependencies of the refractive index of etalon materials.

Monolithic construction of various embodiments of wavelength meter device 29 ensures long-term mechanical stability and ruggedness. Three etalons 199 move in lockstep due to variations in the operating environment of the device. Optical contacting and absence of adhesives ensures long-term precision of the device by maintaining long-term stability of optical paths 222, 223 and 224, and surface reflectivities 214 and 220. As a result, recalibration of the device would be unnecessary under most conditions. In the event that recalibration is necessary or desirable, the procedures required are greatly simplified by the construction technique. Absolute wavelength recalibration may be accomplished with a single point measurement of three partial orders e₀₁, e₀₂, e₀₃ of the three etalons 199 at a known wavelength. A two-point calibration may be used to update the FSR of each of the three etalons 199 for use in extreme temperature environments, or to check self-consistency.

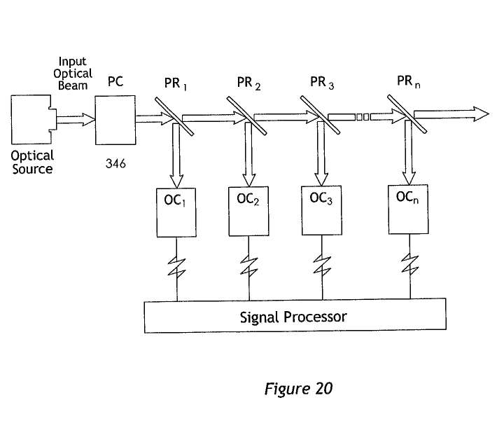

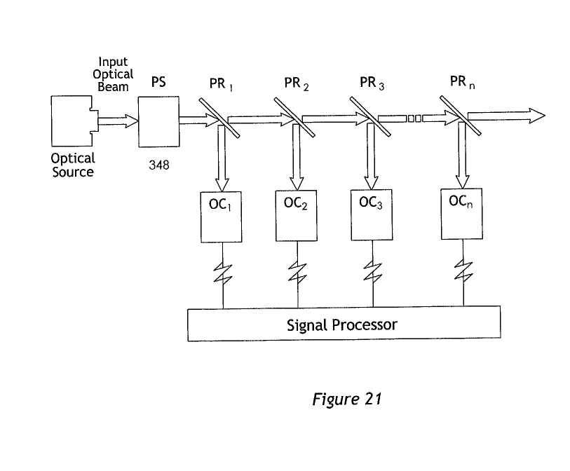

A potential problem for the previously mentioned embodiments of wavelength meter device 29 is the reflectivity of partial reflectors 30, 32, 34 and 36 depend on the state of polarization (SOP) of optical beam 28. Hence, the calibration of the wavelength meter device must account for variations with SOP. In environments where the SOP is well-known and controlled, such as free-space propagation within a laser package or along a polarization-maintaining fiber, polarization dependence is not an issue. However, for light transmitted through a single-mode fiber to wavelength meter device 29, the SOP will change over time. As illustrated in FIG. 20, a first way of mitigating polarization effects in wavelength meter device 29 is to employ a polarization control (PC) device 346 that produces a well-defined output SOP for any input SOP. A PC device ensures that the polarization effects in wavelength meter device 29 do not change with time, allowing for a single, well-known correction for polarization systematics in the optical frequency calculation of FIG. 9. The Coming Acrobat or General Photonics polarization controllers used in feedback mode are examples of PC devices. Alternatively, an optic of fixed, polarization-insensitive transmission may suffice (e.g. a polarizer or other optic generating a single, known SOP). A second embodiment for mitigating polarization effects removes polarization effects in wavelength meter device 29 by using a polarization scrambler (PS) device. As illustrated in FIG. 21, PS 348 changes the SOP more quickly than the response rate of the detection electronics thereby averaging-out polarization effects. PS 348 may comprise devices with a spatial gradient in birefringence to create a random SOP; or, for optical features with linewidths on the order of about a GHz or more, devices employing recirculating loops (e.g. Alliance Fiber Optics' All fiber Optical Depolarizer) or Lyot filters; or, pseudo-randomizing devices (e.g. ILX Lightwave's PSC-8420).

An improvement of the present invention is to use precise measurement of optical frequency to feedback to the optical source and control the optical frequency. Devices that control or regulate the optical source to a specific optical frequency (or wavelength) are called wavelength lockers. Each of the aforementioned embodiments of a wavelength meter device may be coupled to an optical source, and the information about the optical wavelength may be used as a feedback mechanism to control the source. The feedback bandwidth (and the optical frequency measurement bandwidth) of a wavelength locker device must exceed the bandwidth of noise on optical source 26. Using a DSP as signal processor 62 to perform the optical frequency calculations, more than a thousand, and as many as ten thousand or more, optical frequency measurements may be possible per second. The timescale of monitoring is suited to corrective action on many of the parameters that change the optical frequency of a source. For example, in the case of laser diodes used in telecommunication systems, laser diode current and temperature may two fundamental control parameters that may change on the timescale of tens of milliseconds to seconds. In addition, laser diode performance changes as the diode ages over the timescale of months. All of these parameters may be controlled with an optical wavelength measurement with an update rate of 1 KHz or faster.

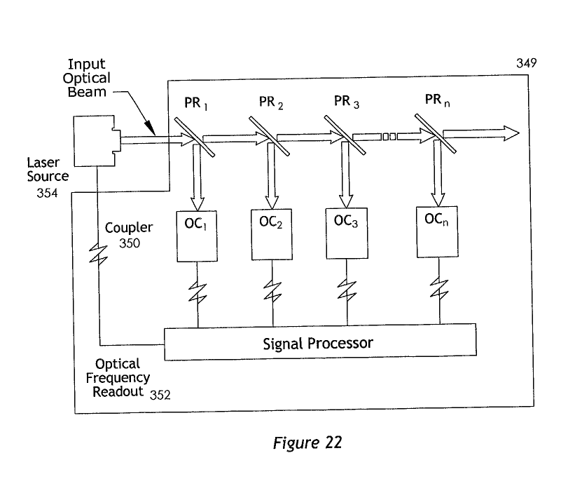

One embodiment of a wavelength locking device 349 is described in FIG. 22. Wavelength locker 349 combines wavelength meter device 29 and a coupler 350 coupling optical frequency readout 352 to the optical source 354. Readout 352 may consist of an optical frequency, possibly read by the source through an interface format such as PXI, GPIB or RS-232. Alternatively, the optical frequency readout 352 may simply communicate deviations from a set-point optical frequency at which source 354 must remain locked. Communicating the change may prove faster than communicating the absolute value of the optical frequency. The communication of change might take the form of a number communicated by interface, or as a voltage proportional to the change that is a simple analog input to the optical source.

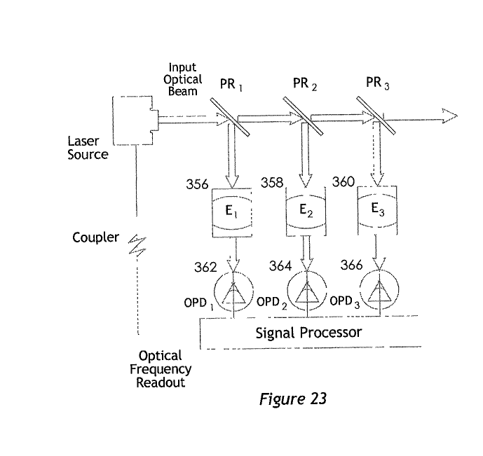

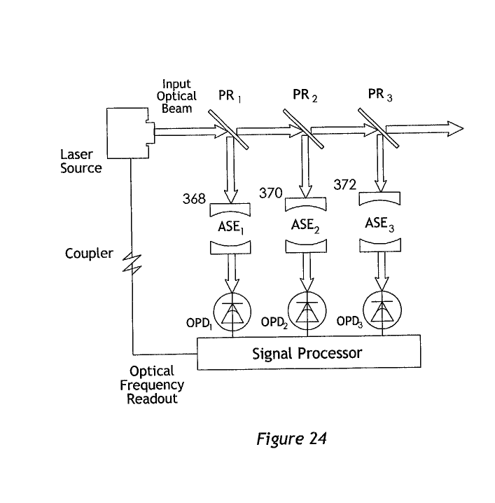

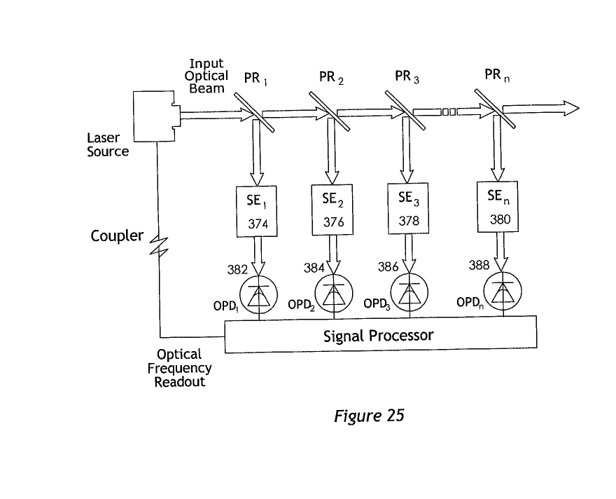

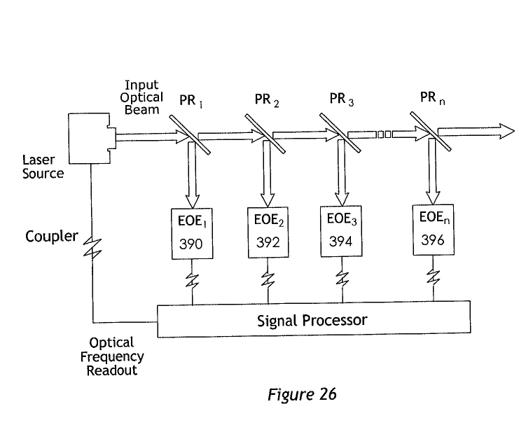

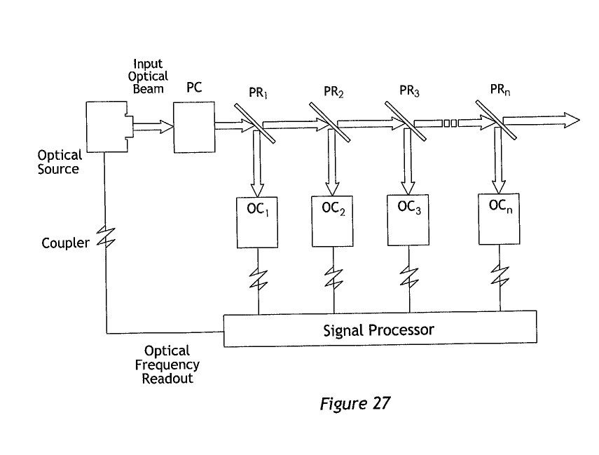

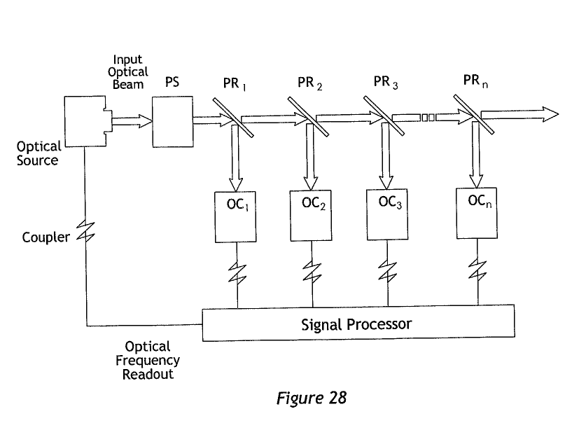

A myriad of wavelength locking devices 349 are possible based on the wavelength meter device embodiments of the present invention. FIG. 23 shows a wavelength locking device consisting of a wavelength meter device made of etalons (Eᵢ) 356, 358 and 360 and optical power detectors (OPDᵢ) 362, 364 and 366 wherein coupler 350 couples optical frequency readout 352 to optical source 354. FIG. 24 shows a wavelength locking device consisting of a wavelength meter device made of air-spaced etalons (ASEᵢ) 368, 370 and 372, and OPDs. FIG. 25 shows a wavelength locking device consisting of a wavelength meter device made of solid etalons (SEᵢ) 374, 376, 378 and 380 and OPDs 382, 384, 386 and 388. FIG. 26 shows a wavelength locking device consisting of a wavelength meter device made of electro-optic elements (EOEᵢ) 390, 392, 394 and 396. FIG. 27 shows a wavelength locking device consisting of a wavelength meter device made of a polarization controller (PC) 346 and optical components (OCᵢ) 46, 48, 50 and 52 that generate signals periodic in optical frequency. FIG. 28 shows a wavelength locking device consisting of a wavelength meter device made of a polarization scrambler (PS) 348 and optical components (OCᵢ) 46, 48, 50, 52 that generate signals periodic in optical frequency.

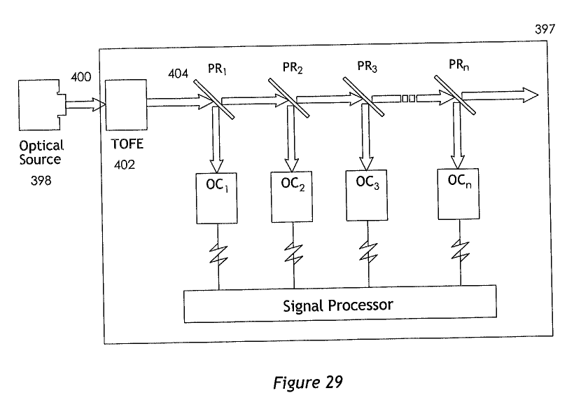

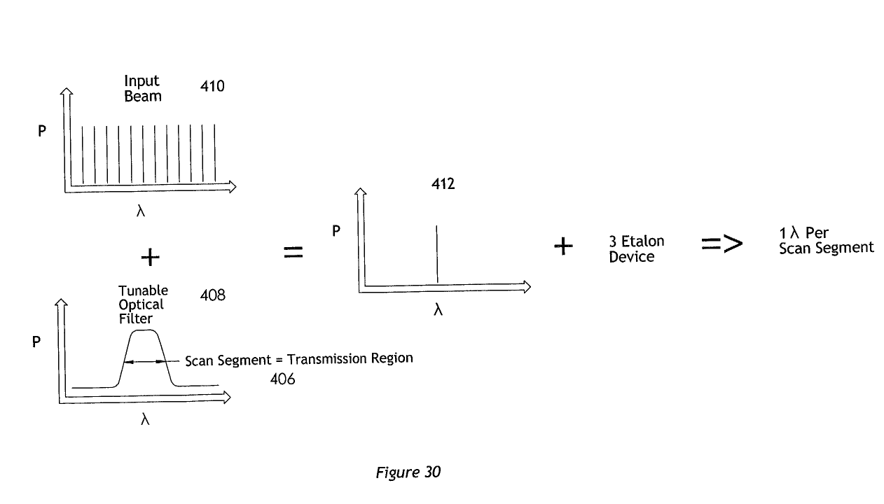

Each of the embodiments of wavelength meter 29, which measure a single optical wavelength, may form the basis for a wavelength meter device capable of measuring multiple optical wavelengths. FIG. 29 illustrates a multi-wavelength meter device 397. Optical source 398 generates first optical beam 400, which enters a tunable optical filter element (TOFE) 402. TOFE 402 generates a second optical beam 404. A wavelength meter device 29 is positioned at least partially in second optical beam 404. The TOFE restricts the measurement wavelength range to the transmission region of TOFE 402. FIG. 30 illustrates the operating principle. A transmission region 406 of TOFE 402 is shown in transmission spectrum 408, assures resolution of the smallest spectral feature. The TOFE scans from a calibrated start wavelength or scans at a calibrated rate. Note that the accuracy of the TOFE scan does not limit the accuracy of the multi-wavelength measurement. Optical spectrum 410 illustrates the optical frequencies present in optical beam 400. Optical frequencies that are outside the transmission region 406 of TOFE 402 are suppressed and only an optical frequency within transmission region 406, at a specific moment in the scan, transmits to wavelength meter device 29 to make a single, highly accurate and precise measurement. The resultant optical spectrum from convolving the optical spectra 408 and 410 is shown in optical spectrum 412. An example of a TOFE is available from Micron Optics.

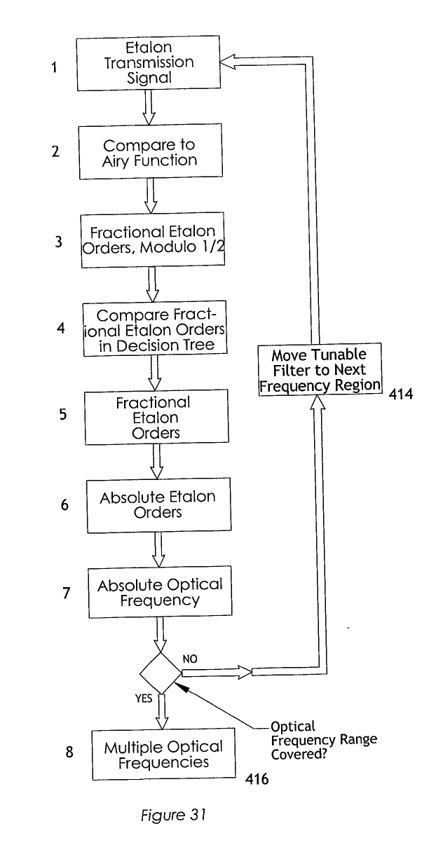

The algorithm for measuring multiple optical frequencies is shown in FIG. 31. The multi-wavelength measurement algorithm consists of the previously described algorithm for wavelength measurement in the three-etalon device (Steps 178, 180, 182, 184, 186 and 188) and a loop step 414 for iterating the TOFE to scan multiple optical frequency regions and to assign a single frequency to the light in said optical frequency scan segment. Compiling the results of multiple scan segments (8^{th} Step 416) allows for the accurate determination of optical spectrum 410 with precision of single-wavelength meter device 29, an ability to resolve nearby wavelengths determined by the width transmission region 406 of TOFE 402, a measurement time determined by the scanning time TOFE 402, and a wavelength range dictated by the calibrated scan range of TOFE 402 and the operating range of wavelength meter device 29.

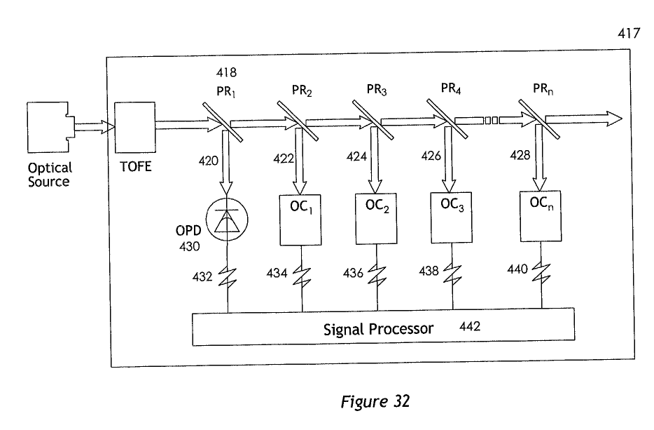

When combined with accurate power measurements with wide dynamic range, multi-wavelength meter device 397 becomes an optical spectrum analyzer (OSA) or optical channel monitor (OCM). A particularly important application is in monitoring spectra of a DWDM system, in which many laser sources, each with narrow spectral linewidth, are multiplexed in a single optical fiber. One optical spectrum analyzer device 417, shown in FIG. 32, is suited to measuring the wavelengths and optical power of individual optical channels in a DWDM system. Referring to FIG. 32, optical source 398 generates first optical beam 400. TOFE 402 is positioned at least partially in first optical beam 400, generating a second optical beam 404 with a narrowed optical frequency spectrum (as discussed above). A sequence of partial reflectors (PR₁, PR₂, . . . PRₙ) 418, 30, 32, 34 and 36 generate optical beams 420, 422, 424, 426 and 428. An optical power detector (OPD) 430 is arranged in optical beam 420 and generates a signal 432 in proportion to the optical power of second optical beam 404. Optical beam 420 need not be generated prior to any other of the optical beams 422, 424, 426 and 428. Optical components (OC₁, OC₂ . . . OCₙ) 46, 48, 50 and 52 are arranged in optical beams 422, 424, 426 and 428, generating signals 434, 436, 438 and 440. Signals 432, 434, 436, 438 and 440 couple to signal processor 442 for determination of the optical spectrum of optical beam 400.

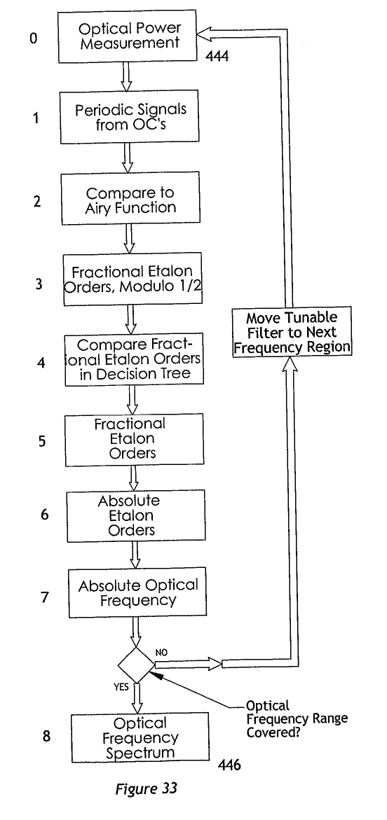

An algorithm for measuring the optical frequency spectrum (FIG. 33) builds upon the multi-wavelength measurement algorithm. One embodiment of an optical spectrum analyzer 417 first measures optical power (0^{th} Step 444, FIG. 33). Optical power measurement 444 may be used to normalize the signals from optical components 46, 48, 50 and 52. The algorithm then determines the optical frequency with the bandwidth of TOFE 402, and assigns the optical power measured in Step 444 with the optical frequency measured in 1^{st} through 7^{th} Steps 178, 180, 182, 184, 186 and 188. Scanning TOFE 402 and measuring a sequence of optical frequency segments in loop 414 allows for construction of the optical spectrum over the entire scan range of TOFE 402 (8^{th} Step 446, FIG. 33).

In one embodiment, the width of the transmission region 406 of TOFE 402 is narrower than the channel spacing in the monitored optical system, which allows discrimination of one wavelength from another. The present embodiment requires a large dynamic range of power measurement 444 to monitor the possibly large attenuation of specific wavelengths within a DWDM system. Automatic gain switching in the electronics is one method of generating a large dynamic range of the power measurement of at least about 30 dB.

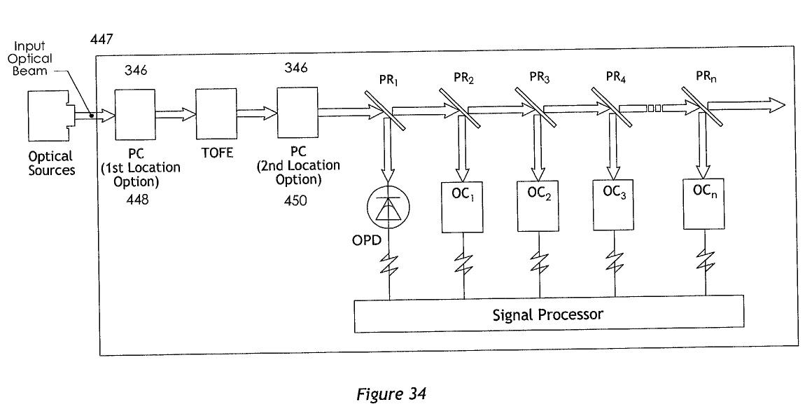

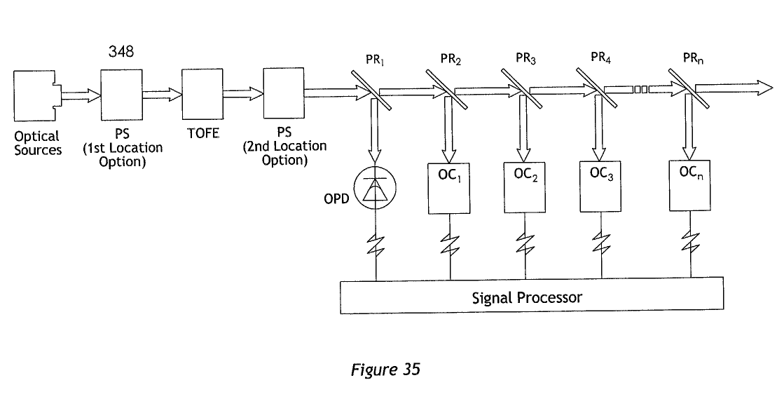

A set of embodiments of the OSA 417 address the need to mitigate the polarization dependence in the wavelength meter device 29 and power measurements 444. Problems arise, in part, because the responsivites of OPD 430 and OPDs in optical components 46, 48, 50 and 52 are polarization sensitive and because the SOP of each wavelength in a DWDM system is generally different and changes at different rates and amounts. One embodiment of a polarization-mitigated multiple-wavelength meter device 447, shown in FIG. 34, uses either an optical element that permits transmission of a single state of polarization, regardless of the input state or wavelength (a polarization homogenizer or polarization controller PC 346). Another embodiment (FIG. 35) uses a polarization scrambler (PS) 348 to randomize the input state of polarization on a timescale of the measurement of each optical frequency in a multi-frequency measurement. A polarization controller that actively controls the SOP of each optical frequency may also mitigate polarization effects. A multi-channel polarization controller is not the preferred polarization mitigation scheme because of the cost and the difficulty controlling the SOP of multiple optical frequency channels. Current techniques require de-muxing the multi-frequency optical beam, individually controlling the SOP of each channel, and re-muxing the optical frequencies into a single beam. The preferred solutions, a polarization scrambler or polarization homogenizer, may be placed prior to the TOFE 402 (1^{st} location option 448) or between the TOFE 402 and the wavelength meter device 405 (2^{nd} location option 450). Another method of reducing polarization effects is to remove polarization dependence from the optical power detectors (OPDs), as in FIGS. 6. One embodiment combines an integrating sphere 138 with OPD 140. The integrating sphere may contain a hollow cavity 144 or consist of a solid interior 148 that randomizes the state of polarization of light through multiple reflections off a diffusive reflection surface inside the sphere.

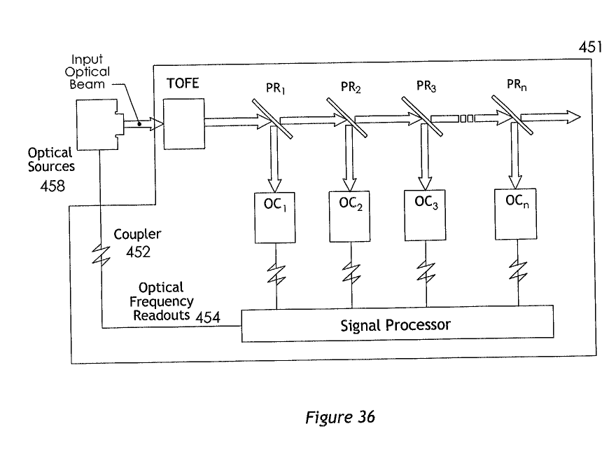

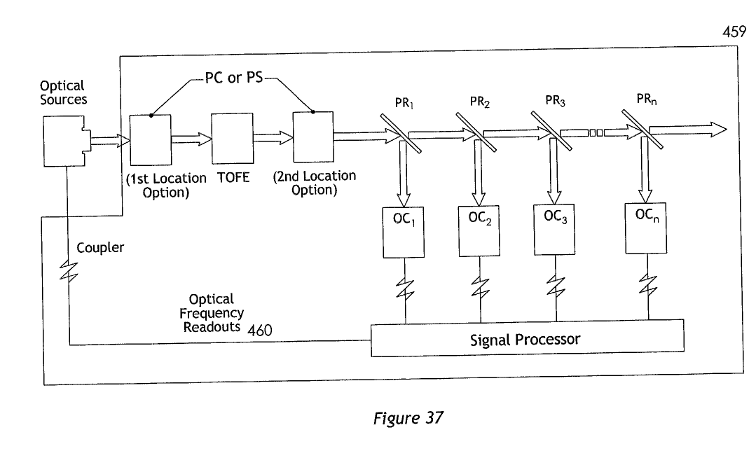

Multiple-wavelength meter device 397 may be used to feedback optical frequency information to an optical source, or sources, and thereby control the optical frequencies. Referring to FIG. 36, one embodiment of a multi-wavelength locking device 451 uses coupler 452 to couple optical frequency readouts 454 from a multiple-wavelength meter device 397 to an optical source or sources 458. Considering the importance of polarization effects, FIG. 37 shows one embodiment of a multiple-wavelength locking device 459 wherein optical frequency readouts 460 couple from a polarization-mitigated multiple-wavelength meter device 447 to optical source or sources 458. Polarization effects are mitigated by a polarization controller (PC) 346 or polarization scrambler (PS) 348 positioned either before or after TOFE 402.

An improved set of embodiments monitor optical power within wavelength meter device 29 as a means of normalizing power fluctuations from signals 54, 56, 58 and 60. Signal variations due to changes in the optical power of the optical source may be reduced or removed by dividing said frequency-dependent signals with a signal in proportion to the optical power of the optical source. This Second Class of wavelength meter devices have no reliance on an external power measurement and achieve simplicity of self-reliance at a minimum of additional cost.

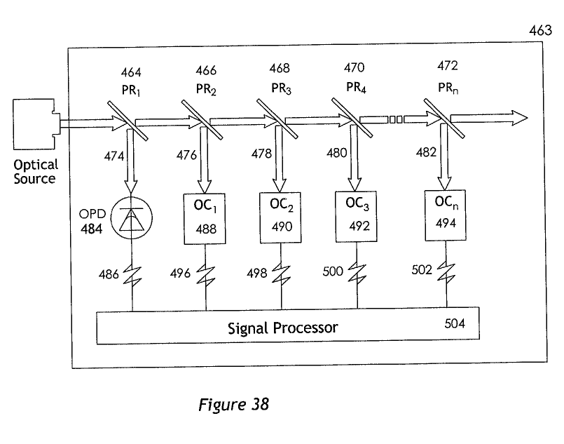

A general embodiment of a wavelength meter device with optical power detection 463 is shown in FIG. 38. Optical source 26 generates optical beam 28. A sequence of partial reflectors (PR₁, PR₂, PR₃ . . . PRₙ) 464, 466, 468, 470 and 472 positioned at least partially in optical beam 28, generate optical beams 474, 476, 478, 480 and 482. Optical power detector (OPD) 484 generates a signal 486 in proportion to the optical power of optical beam 28. Optical components (OC₁, OC₂, OC₃ . . . OCₙ) 488, 490, 492 and 494 generate signals 496, 498, 500 and 502. Signals 486, 496, 498, 500 and 502 couple to signal processor 504 for determination of the optical frequency of optical beam 28.

The algorithm for calculating the optical frequency is identical to the method of FIG. 5, with the exception that the optical power signal is derived from OPD 484. Proper normalization using OPD signal 486—which achieves a cancellation of common-mode noise and optical power variations—requires a careful accounting for the various insertion losses and partial reflectivity into optical components 488, 490, 492 and 494, in addition to possible wavelength and temperature dependencies.

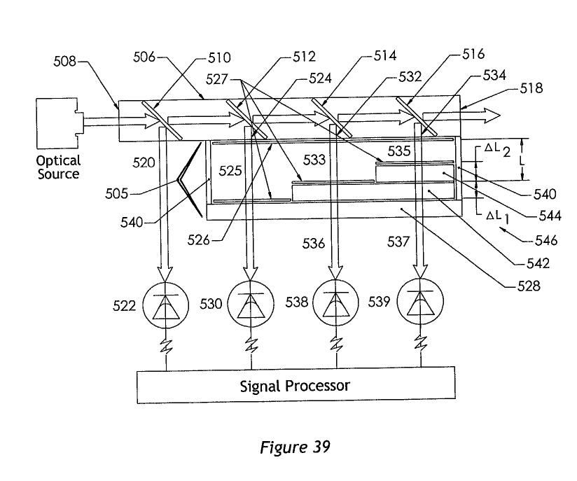

FIG. 39 illustrates an embodiment of a wavelength meter device with optical power detection 463 consisting of three air-spaced etalons 505. Input optical beam 28 enters beamsplitter structure 506 through entrance surface 508, and is split into four substantially equal parts by first beamsplitter 510, second beamsplitter 512, third beamsplitter 514 and fourth beamsplitter 516. Remaining optical power exits through an antireflection coated exit window 518. Optical beam 520 reflected from first beamsplitter 510 is directed to OPD 522 to monitor the optical power of beam 28. Optical beam 524 reflected from second beamsplitter 512 is directed towards a first etalon 525, entering through reflecting surface 526, exiting through reflecting surface 527 on the optical element 528 and is detected by OPD 530. Surfaces 526 and 527 may consist of a partial reflectivity coating. Optical beam 532 enters second air-spaced etalon 533. Optical beam 534 enters third etalon 535. Optical beams 536 and 537, generated by etalons 533 and 535 respectively, are detected by OPDs 538 and 539. The first reflective surface 526 is separated from second reflective surfaces 526 by a spacer element 540. Thin film pattern coatings 542 and 544, of thicknesses ΔL₁ and ΔL₂, are layered on optical element 528. The layer thicknesses ΔL₁ and ΔL₂ may be identical, but may also differ according to certain criteria as discussed below. Layer 542 covers about ⅔ of element 528. Layer 544 covers about ⅓ of element 528. Layers 542 and 544 are overlapped such that three regions are formed with about the same area, but consisting of three different optical path lengths making up etalons 525, 533 and 535. Those skilled in the art will notice that a variety of beam splitting ratios can be used in the case where only a small portion of the total laser power is used or when the reflected signals from the etalons rather than the transmitted signals are used in an alternative embodiment.

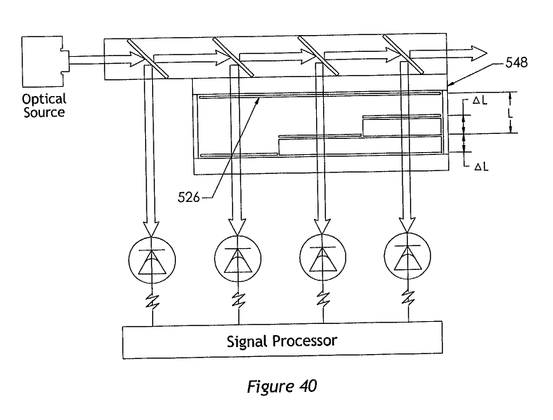

An alternative embodiment of the wavelength meter device consisting of optical power detection 463 is shown in FIG. 40. An optically flat element 548, made of a surface coating 526 with partial reflectivity, creates the first surface of the three air-spaced etalons 199. The separation of the beamsplitter from the etalon optical surfaces may make the wavelength meter device 463 more manufacturable by placing the precision reflectivity coating on element 548, rather than directly on the four beamsplitter structure 506.

In both embodiments illustrated in FIGS. 39 and 40, the precise path length differences between the air-spaced etalons 525, 533 and 535 are created by thin film deposition of layers 542 and 544 onto the surface of element 528 inside the airspace. The length differences ΔL₁ and ΔL₂ may be equal to an odd multiple of one-sixteenth of the central operating wavelength to ensure that frequency ƒ is in the high slope region of the transmission spectra of at least two etalons over the wavelength range of wavelength meter device 463. The invention is not fundamentally changed by choosing non-identical path length differences, but rather the details of the algorithm for calculating wavelength are altered. Two of the various embodiments of the invention in FIGS. 39 and 40 use identical path-length differences ΔL₁=ΔL₂ =ΔL. Reflectivity of surface coatings 526 and 527 should optimally be around 0.25. Among the various embodiments, etalon spacer 540 is optically flat and the etalon is constructed by optically contacting spacer 540 to beamsplitter 506 and the pattern-coated element 528.

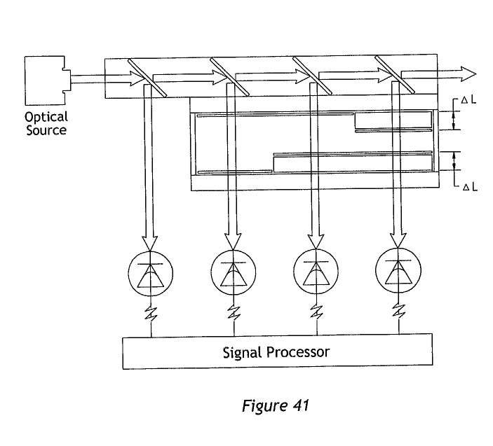

Identical path length differences in air-spaced etalons 525, 533 and 535 may be more easily achieved in an embodiment of wavelength meter device 463 shown in FIG. 41. Two pattern coatings of non-identical length, but identical thickness are applied to optical elements 528 and 548 during the same coating run. As in wavelength meter device 243, layer 544 applied to element 548 is substantially ⅓ the length of the portion of element 548 making the three etalons. Layer 542 on element 528 is substantially ⅔ of the portion of element 528 making the air-spaced etalon. Alternatively, layer 544 may be applied to element 528 and layer 542 may be applied to element 548. Partial reflectivity coatings 526 and 527 are applied over thin film coating 542 and 544 and the surfaces of elements 528 and 548 that face inside the air-gapped etalons 525, 533 and 535. Overlapping the two substrates, as in FIG. 41, three etalons are created with equal length differences ΔL. Spacer 540 separates elements 528 and 548.

Embodiments of wavelength meter device 463, consisting of air-spaced etalons 525, 533 and 535, may be constructed with a variety of techniques. The temperature sensitivity of the etalon lengths may be reduced by constructing spacer 540 from a material of low thermal expansion coefficient such as Zerodur, ULE or others. In the case of Zerodur, the desired wavelength accuracy of wavelength meter device 463 can be maintained over a range of several degrees without other temperature compensation. Structure 505 may be robustly constructed by joining the optical components (such as beamsplitter 506, spacer 540, and elements 528 and 548) with optical contacting methods. By optical contacting we refer to a variety of techniques including, but not limited to, wafer bonding, ringing, adhesion through optical contact, anodic bonding and diffusive bonding.

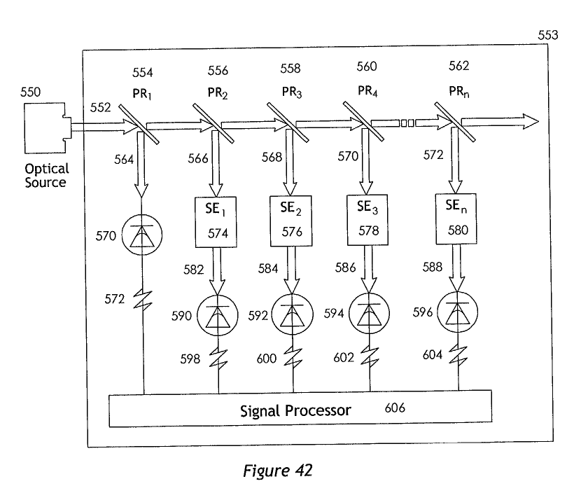

Constructing wavelength meter device 463 from solid etalons may prove more easy to manufacture than three air-spaced etalons 505. Moreover, solid etalons may be 50% smaller when composed of fused silica, for example. Referring to FIG. 42, optical source 550 generates a first optical beam 552. Optical beam 552 enters wavelength meter device 553. Partial reflectors (PR₁, PR₂, PR₃. . . PRₙ,) 554, 556, 558, 560 and 562 positioned at least partially in first optical beam 552, generate optical beams 564, 566, 568, 570 and 572. Optical power detector 570 generates a signal 572 in proportion to the optical power of optical beam 552. Solid etalons 574, 576, 578 and 580 (SE₁, SE₂, SE₃. . . SEₙ) generate optical beams 582, 584, 586, 588 relative to the frequency of optical beam 552 and the length, finesse and material properties of solid etalons 574, 576, 578 and 580. Optical power detectors 590, 592, 594 and 596 generate signals 598, 600, 602 and 604. Signals 598, 600, 602 and 604 couple to signal processor 606 for determination of the optical frequency of optical beam 552. A calculation algorithm substantially similar to the schematic of FIG. 9, and accounting for the dispersion of solid etalons, calculates the optical frequency.

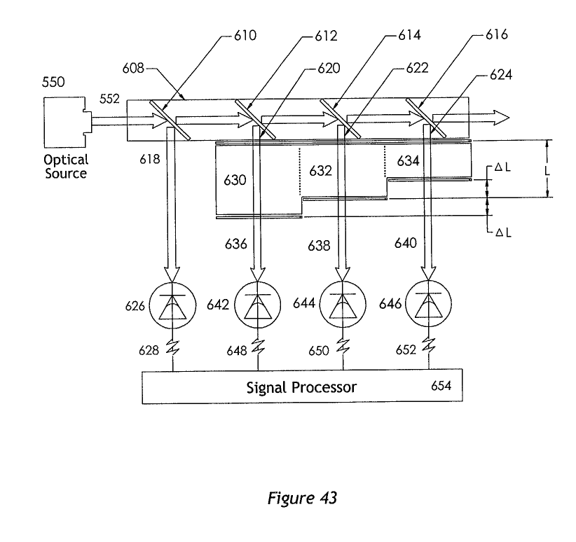

One of various embodiments of a wavelength meter device 553 is shown in FIG. 43. Beamsplitter 608, consisting of four partially reflective surfaces 610, 612, 614 and 616, is positioned at least partially in optical beam 552. Partial reflectors 610, 612, 614 and 616 generate optical beams 618, 620, 622 and 624. Optical beam 618 is detected by optical power detector (OPD) 626, which generates a signal 628 in proportion to the power of optical beam 552. Solid etalons 630, 632 and 634 optically contacted to beamsplitter 608, are positioned at least partially in the path of optical beams 620, 622 and 624. The solid etalons generate three optical beams 636, 638 and 640 relative to the lengths of solid etalons 630, 632 and 634, their index of refraction (for example about 1.44 for fused silica) and their finesse (of about 2 or greater). The etalon lengths differ by equal amounts ΔL, where ΔL is an odd multiple of one-sixteenth of the central wavelength of the operating range of the wavelength meter device. OPDs 642, 644 and 646 detect optical beams 636, 638 and 640, respectively, generating signals 648, 650 and 652, respectively. Signals 628, 648, 650 and 652 couple to signal processor 654. Signal processor 654 employs a calculation algorithm substantially similar to the schematic of FIG. 9, with additional accounting for the dispersion of solid etalons, to calculate the optical frequency.

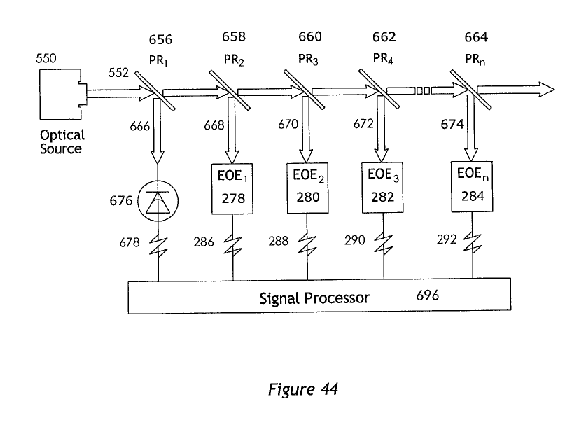

An embodiment of a wavelength meter device 463 consisting of electro-optical elements 278, 280, 282 and 284 in place of optical components 488, 490, 492 and 494 is shown in FIG. 44. Optical source 550 generates first optical beam 552. Partial reflectors 656, 658, 660, 662 and 664 (PR₁, PR₂, PR₃ . . . PRₙ), positioned at least partially in optical beam 552 generate optical beams 666, 668, 670, 672 and 674. An optical power detector 676 generates signal 678 in proportion to the optical power of optical beam 552. Electro-optic elements 278, 280, 282 and 284 (EOE₁, EOE₂, EOE₃ . . . EOEₙ) generate signals 286, 288, 290 and 292 relative to the optical frequency of optical beam 552 in response to passage of the optical beams through the EOEs. The EOEs may take the form of birefringent material 294 with polarizer 296 or planar waveguide resonator planes 326, 324 and 322. Generally the EOEs consist of a component that generates a signal periodic with the optical frequency of detected light. Signals 678, 286, 288, 290 and 292 couple to signal processor 696 to determine the optical frequency of optical beam 552, using the algorithm of the schematic of FIG. 9.

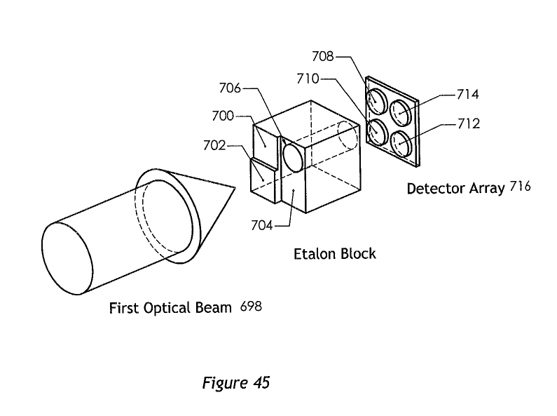

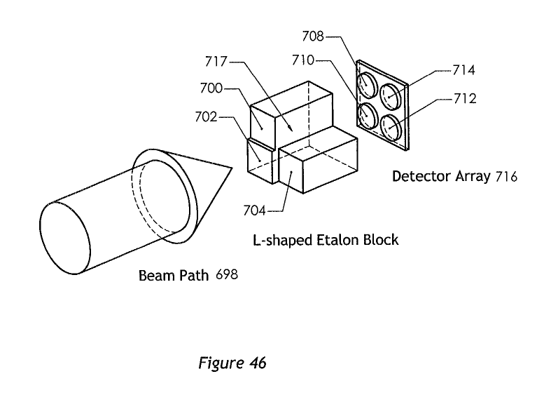

Another embodiment of wavelength meter device 463 reduces or eliminates polarization effects by removing polarization sensitive components such as partial reflectors 464, 466, 468, 470 and 472 and 1 by 4 beamsplitter 506. Referring now to FIG. 45, a first optical beam 698 is incident, at least partially, on etalons 700, 702 and 704 and a fourth optical path 706 without etalon. The etalons may be air-spaced or solid, and are substantially similar to the etalons of previously mentioned embodiments. Fourth optical path 706 may consist of a glass substrate with a clearance aperture that joins to three etalons. Light transmits through etalons 700, 702 and 704 and fourth optical path 706 and is detected, respectively, by optical power detectors 708, 710 and 712 and 714 on detector array 716. The clearance hole of fourth optical path 706 allows for unobstructed detection of at least a portion of the optical power of first optical beam 698. The optical power detected by detector 714 serves as a power reference for the device. In another of various embodiments of a polarization insensitive wavelength meter device (FIG. 46), first optical beam 698 is incident upon three etalons 700, 702 and 704 that join together to form an L-shaped cross section. The open crux of the L-structure creates fourth optical path 717.

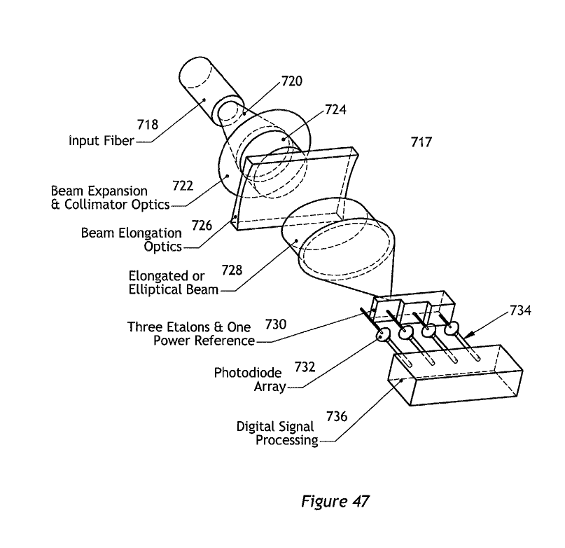

FIG. 47 illustrates yet another of various embodiments of a polarization insensitive wavelength meter device 717. An input fiber 718 is the source of a first optical beam 720. Optical beam 720 is expanded and collimated by optics 722 that generate optical beam 724. Beam elongation optics 726 expand optical beam 724 asymmetrically to form an elongated or elliptical beam 728. Three etalons and an unobstructed optical path 730 are positioned at least partially in optical beam 728. Optical beams generated by 730 are detected by photodiode array 732. Array 732 generates photodiode signals 734 that couple to digital signal processing 736 for calculation of optical frequency of optical beam 720.

In each of the embodiments of FIG. 45, 46 and 47, the light transmitted through four paths (etalons 700, 702, 704 and optical reference path 706, or structure 730) is detected by an array of photodetectors 716 and 732 such as a quadrant photodiode 126, photodiode array 124, or the like. The etalons may be optically contacted together to form a monolithic structure. Since no beam splitters are used, the polarization dependence of the light along each path is greatly reduced. Beyond these designs, further reduction of the polarization dependence may be achieved by using integrating sphere 138 with photodiode arrays 716 and 732.

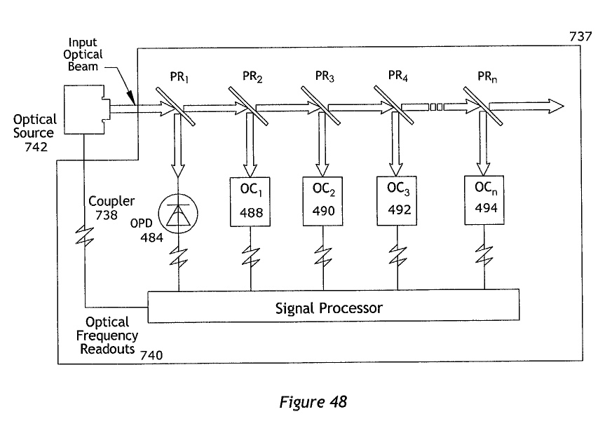

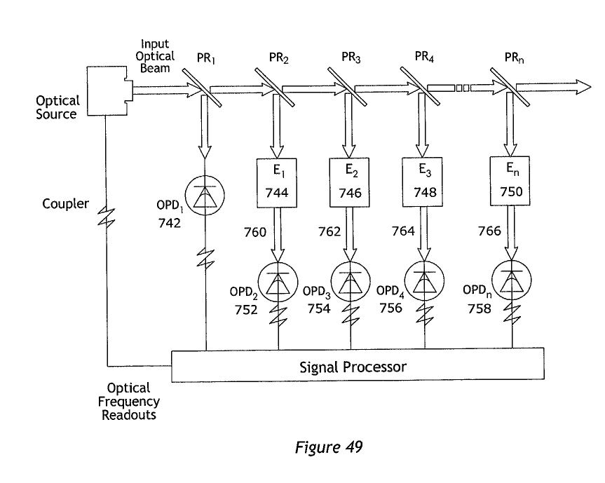

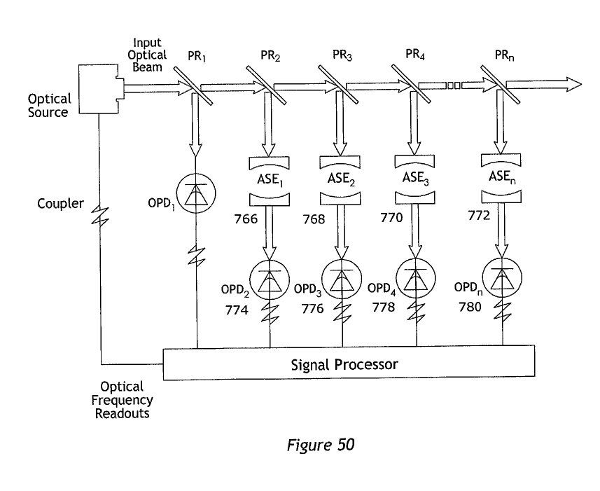

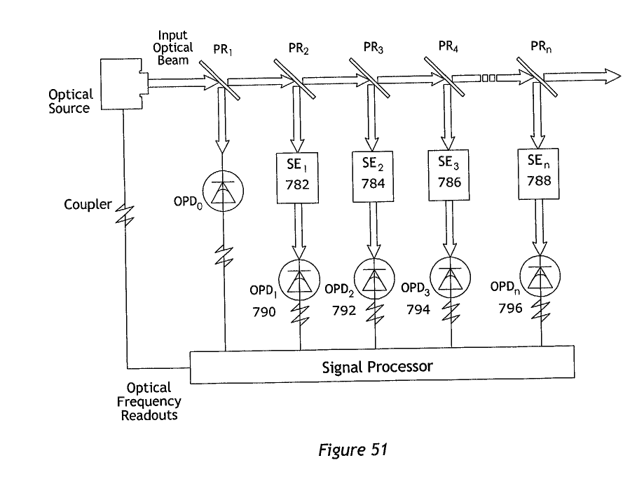

Another of the various aspects of the present invention is a wavelength locking device 737 consisting of wavelength meter device 463 and a coupler 738. The strategy is substantially similar to the wavelength locker 349. In contrast to previous embodiments, the wavelength stability of the lock is improved by a normalization signal derived from optical power measurement. An embodiment, shown in FIG. 48, relies upon the wavelength meter device 463, consisting of optical power detector 484, frequency-dependent optical components 488, 490, 492 and 494 (OCᵢ), and a coupler 738 coupling optical frequency readouts 740 (or readout of deviation from a set-point optical frequency) to the optical source 742. The coupling comprises substantially similar designs as discussed in the wavelength locking device 349. One embodiment shown in FIG. 49 includes power measurement in optical power detector 742 (OPDᵢ), etalons (Eᵢ) 744, 746, 748 and 750 and optical power detectors (OPDᵢ) 752, 754, 756 and 758 that detect optical beams 760, 762, 764 and 766 generated by the etalons. Another embodiment shown in FIG. 50 includes air-spaced etalons (ASEᵢ) 766, 768, 770 and 772 with optical power detectors 774, 776, 778 and 780. Yet another embodiment shown in FIG. 51 includes solid etalons (SEᵢ) 782, 784, 786 and 788 and optical power detectors 790, 792, 794 and 796.

What is claimed is:

1. A wavelength meter device, comprising:
a plurality of optical components each positioned at least partially in a path of a first optical beam, each optical component generating a signal relative to at least a portion of optical frequencies of the first optical beam in response to passage of a portion of the first optical beam through at least a portion of each optical component of the plurality of optical components; and
wherein each signal is periodic with an optical frequency of the first optical beam, and phase shifts between each signal vary over multiple periods of each signal, and an optical frequency is determined with a uncertainty of less than the period of signal generated by the plurality of optical components.

2. The device of claim 1 wherein the signals from the plurality of optical components determine an optical frequency.

3. The device of claim 1 wherein each of the plurality of optical components comprises:
an interferometric optical element that generates an interferometric optical element beam relative to a frequency of a portion of the first optical beam; and
an optical power detector that generates a signal in proportion to the optical power of the interferometric optical element beam.

4. The device of claim 3 wherein the optical power detectors comprise photodiodes.

5. The device of claim 3 wherein the optical power detectors comprise an array of photodiodes.

6. The device of claim 3 wherein the optical power detectors comprise a photodiode that includes separate signal producing regions.

7. The device of claim 3 wherein each optical power detector that generates a signal in proportion to the optical power of the interferometric optical element beam comprises an optical integrating sphere and photo detector.

8. The device of claim 7 wherein the optical integrating sphere comprises a substantially hollow cavity.

9. The device of claim 7 wherein the optical integrating sphere comprises a substantially solid cavity.

10. The device of claim 3 wherein the interferometric optical elements are etalons.

11. The device of claim 2 wherein the optical power detectors comprise photodiodes.

12. The device of claim 10 wherein the optical power detectors comprise an array of photodiodes.

13. The device of claim 10 wherein the optical power detectors comprise a photodiode that includes separate signal producing regions.

14. The device of claim 10 wherein each optical power detector that generates a signal in proportion to the optical power of the interferometric optical element beam comprises an optical integrating sphere and photo detector.

15. The device of claim 14 wherein the optical integrating sphere comprises a substantially hollow cavity.

16. The device of claim 14 wherein the optical integrating sphere comprises a substantially solid cavity.

17. The device of claim 10 wherein optical beam paths comprise optical elements coupled without adhesive bonding.

18. The device of claim 17 wherein optical beam paths comprise optical elements coupled with optical contacting of surfaces.

19. The device of claim 10 wherein each etalon has an optical transmission characterized by finesse, the finesse of each etalon greater than or equal to about 2.

20. The device of claim 19, wherein said device operates from a minimum optical wavelength to a maximum optical wavelength, the lengths of each etalon differ from each other by odd multiples of substantially one-sixteenth of the wavelength of the input optical beam that is the average of the minimum and maximum optical wavelengths.

21. The device of claim 20 wherein the smallest difference between etalon lengths is substantially equal.

22. The device of claim 21 wherein the signals from the plurality of optical components determine an optical frequency.

23. A wavelength locking device that controls the optical frequency of an optical source, comprising:
a wavelength meter device that comprises a plurality of optical components each positioned at least partially in a first optical beam received from an optical source,
each optical component of the wavelength meter device comprising an etalon and an optical power detector, each etalon generating an etalon optical beam relative to at least a portion of optical frequencies of the first optical beam in response to passage of a portion of the first optical beam through a portion of each etalon; and
each optical power detector generates a signal in proportion to the optical power of the etalon optical beam; and each etalon has an optical transmission characterized by finesse, the finesse of each etalon greater than or equal to about 2; and the wavelength meter device operating from a minimum optical wavelength to a maximum optical wavelength, the lengths of each etalon differ from each other by odd multiples of substantially one-sixteenth of the wavelength of the input optical beam that is the average of the minimum and maximum optical wavelengths; and the smallest difference between etalon lengths is substantially equal; and each signal is periodic with an optical frequency of the first optical beam, and phase shifts between each signal vary over multiple periods of each signal; and the wavelength meter device determines an optical frequency of the first optical beam with an uncertainty of less than the period of each signal; and
a coupler coupled to the wavelength meter device and configured to couple a readout of optical frequency of the optical source and control optical frequency.

24. The device of claim 19 in which the etalons comprise partially reflective optical elements separated by a distance determined by a spacer with air between the elements.

25. The device of claim 24 wherein the spacer is composed of a material of low thermal expansion coefficient.

26. A wavelength meter device, comprising:
a plurality of air-spaced etalons formed from two optical elements each positioned at least partially in a path of a first optical beam, one element comprising a first partially-reflective surface, and a second element comprising a second surface on which a plurality of segments are formed of thin film layers of substantially different thicknesses and substantially identical or substantially different compositions, the two surfaces separated by a spacer, and each segment generates a segment optical beam relative to at least a portion of optical frequencies of the first optical beam in response to passage of a portion of the first optical beam through a portion of each segment; and
a plurality of optical power detectors, each generating a signal in proportion to the optical power of each segment optical beam; and wherein each signal is periodic with an optical frequency of the first optical beam, and phase shifts between each signal vary over multiple periods of each signal; and the wavelength meter device determines an optical frequency of the first optical beam with an uncertainty of less than the period of each signal.

27. The device of claim 26, wherein the device operates from a minimum optical wavelength to a maximum optical wavelength, the lengths of each etalon differ from each other by odd multiples of substantially one-sixteenth of the wavelength of the input optical beam that is the average of the minimum and maximum optical wavelengths.

28. The device of claim 27 wherein the smallest difference between etalon lengths is substantially equal.

29. The device of claim 28 wherein the optical power detectors comprise photodiodes.

30. The device of claim 28 wherein the optical power detectors comprise an array of photodiodes.

31. The device of claim 28 wherein the optical power detectors comprise a photodiode that includes separate signal producing regions.

32. The device of claim 28 wherein the signals from the plurality of optical components determine an optical frequency.

33. The device of claim 26, comprising at least 3 air-spaced etalons formed from two surfaces, one surface comprising a monolithic beam splitter on which about a continuous ⅔ of the surface is coated with a thin film layer and about a continuous ⅓ is uncoated, and a second surface comprising an optically transparent substrate on which about a continuous ⅓ of the surface is coated with a thin film layer, and about a continuous ⅔ of the surface is uncoated, the layers formed of the same or identical coating procedures, the two surfaces oriented to form 3 air spaces, each air space different from the other by one or two identical thicknesses of thin film, the two surfaces separated by a spacer.

34. The device of claim 24, wherein the device operates from a minimum optical wavelength to a maximum optical wavelength, the lengths of each etalon differ from each other by odd multiples of substantially one-sixteenth of the wavelength of the input optical beam that is the average of the minimum and maximum optical wavelengths.

35. The device of claim 34 wherein the smallest difference between etalon lengths is substantially equal.

36. The device of claim 35 wherein the optical power detectors comprise photodiodes.

37. The device of claim 35 wherein the optical power detectors comprise an array of photodiodes.

38. The device of claim 35 wherein the optical power detectors comprise a photodiode that includes separate signal producing regions.

39. The device of claim 35 wherein the signals from the plurality of optical components determine an optical frequency.

40. A wavelength locking device that controls the optical frequency of an optical source, comprising:
a wavelength meter device that includes a plurality of optical components each positioned at least partially in a first optical beam received from an optical source,
each optical component of the wavelength meter device comprises an etalon and an optical power detector, each etalon, comprising partially reflective optical elements separated by a distance determined by a spacer, generates an etalon optical beam relative to at least a portion of optical frequencies of the first optical beam in response to passage of a portion of the first optical beam through a portion of each etalon; and
each optical power detector generates a signal in proportion to the optical power of the etalon optical beam; and
each etalon has an optical transmission characterized by finesse, the finesse of each etalon greater than or equal to about 2; and the wavelength meter device operating from a minimum optical wavelength to a maximum optical wavelength, the lengths of each etalon differ from each other by odd multiples of substantially one-sixteenth of the wavelength of the input optical beam that is the average of the minimum and maximum optical wavelengths; and the smallest difference between etalon lengths is substantially equal; and
each signal is periodic with optical frequency of the first optical beam, and phase shifts between each signal vary over multiple periods of each signal; and the wavelength meter device determines an optical frequency of the first optical beam with an uncertainty of less than the period of each signal; and
a coupler coupled to the wavelength meter device and configured to couple a readout of optical frequency of the optical source and control optical frequency.

41. A wavelength meter device, comprising:
a plurality of solid etalons each positioned at least partially in a path of a first optical beam, each solid etalon comprising a solid material that transmits light, the end surfaces of each solid etalon prepared substantially parallel to each other and about normal to the direction of optical transmission, the length of each solid etalon substantially different from any other solid etalon; and
each solid etalon generates a solid etalon optical beam relative to at least a portion of optical frequencies of the first optical beam in response to passage of a portion of the first optical beam through a portion of each solid etalon; and
optical power detectors generate a signal in proportion to the optical power of each solid etalon optical beam; and
wherein each signal is periodic with an optical frequency of the first optical beam, and phase shifts between each signal vary over multiple periods of each signal; and the wavelength meter device determines an optical frequency of the first optical beam with a uncertainty of less than the period of any of the plurality of signals.

42. The device of claim 41 wherein said device operates from a minimum optical wavelength to a maximum optical wavelength, the lengths of each etalon differ from each other by odd multiples of substantially one-sixteenth of the wavelength of the input optical beam that is the average of the minimum and maximum optical wavelengths.

43. The device of claim 42 wherein the smallest difference between etalon lengths is substantially equal.

44. The device of claim 43 wherein the optical power detectors comprise photodiodes.

45. The device of claim 43 wherein the optical power detectors comprise an array of photodiodes.

46. The device of claim 43 wherein the optical power detectors comprise a photodiode that includes separate signal producing regions.

47. The device of claim 43 wherein the signals from the plurality of optical components determine an optical frequency.

48. A wavelength locking device that controls the optical frequency of an optical source, comprising:
a wavelength meter device that comprises a plurality of optical components each positioned at least partially in a first optical beam received from an optical source,
each optical component comprising a solid etalon and an optical power detector, each solid etalon comprising a solid material that transmits light with the end surfaces of each solid etalon prepared substantially parallel to each other and about normal to the direction of optical transmission; and each solid etalon generates a solid etalon optical beam relative to at least a portion of optical frequencies of the first optical beam in response to passage of a portion of the first optical beam through a portion of each solid etalon; and
each optical power detectors generates a signal in proportion to the optical power of each solid etalon optical beam; and
each solid etalon has an optical transmission characterized by finesse, the finesse of each solid etalon greater than or equal to about 2; and the wavelength meter device operating from a minimum optical wavelength to a maximum optical wavelength, the lengths of each solid etalon differ from each other by odd multiples of substantially one-sixteenth of the wavelength of the input optical beam that is the average of the minimum and maximum optical wavelengths; and the smallest difference between solid etalon lengths is substantially equal; and
each signal is periodic with an optical frequency of the first optical beam, and phase shifts between each signal vary over multiple periods of each signal; and the wavelength meter device determines an optical frequency of the first optical beam with a uncertainty less than the period of each signal; and
a coupler coupled to the wavelength meter device and configured to couple a readout of optical frequency of the optical source and control optical frequency.

49. A wavelength meter device, comprising:
a plurality of electro-optical elements each positioned at least partially in a path of a first optical beam, each electro-optical element generating a signal relative to at least a portion of optical frequencies of the first optical beam in response to passage of a portion of the first optical beam through at least a portion of each electro-optical element of the plurality of electro-optical elements; and
wherein each signal is periodic with an optical frequency of the first optical beam, and phase shifts between each signal vary over multiple periods of each signal; and the wavelength meter determines an optical frequency of the first optical beam with a uncertainty of less than the period of each signal.

50. The device of claim 49 wherein the signals from the plurality of electro-optical elements determine an optical frequency.

51. A wavelength locking device that controls the optical frequency of an optical source, comprising:
a wavelength meter device that includes a plurality of electro-optical elements each positioned at least partially in a first optical bean received from an optical source,
each electro-optical element of the wavelength meter device generating a signal relative to at least a portion of optical frequencies of the first optical beam in response to passage of a portion of the first optical beam through at least a portion of each electro-optical element of the plurality of electro-optical elements; and
each signal is periodic with an optical frequency of the first optical beam, and phase shifts between each signal vary over multiple periods of each signal; and the wavelength meter device determines an optical frequency with a uncertainty of less than the period of each signal; and
a coupler coupled to the wavelength meter device and configured to couple a readout of optical frequency of the optical source and control optical frequency.

52. A wavelength locking device that controls the optical frequency of an optical source, comprising:
a wavelength meter device that comprises a plurality of optical components each positioned at least partially in a first optical beam received from an optical source; and
each optical component of the wavelength meter generates a signal relative to at least a portion of optical frequencies of the first optical beam in response to passage of a portion of the first optical beam through at least a portion of each optical component of the plurality of optical components; and
each signal is periodic with an optical frequency of the first optical beam, and phase shifts between each signal vary over multiple periods of each signal; and the wavelength meter device determines an optical frequency of the first optical beam with a uncertainty of less than the period of each signal; and
a coupler coupled to the wavelength meter device and configured to couple a readout of optical frequency of the optical source and control optical frequency.

53. A wavelength meter device, comprising:
a polarization controller positioned at least partially along a path of the first optical beam, said first optical beam having an uncontrolled state of polarization, and the polarization controller producing a second optical beam with a state of polarization that does not change substantially during a time interval necessary for a measurement of optical frequency of the first optical beam; and
a plurality of optical components each positioned at least partially in a path of the second optical beam, each optical component generating a signal relative to at least a portion of optical frequencies of the second optical beam in response to passage of a portion of the second optical beam through at least a portion of each optical component of the plurality of optical components; and
wherein each signal is periodic with an optical frequency of the first optical beam, and phase shifts between each signal vary over multiple periods of each signal; and the wavelength meter device is capable of determining optical frequency with a uncertainty of less than the period of signal generated by the plurality of optical components.

54. The device of claim 53 wherein the signals from the plurality of optical components determine an optical frequency.

55. A wavelength locking device that controls the optical frequency of an optical source, comprising:
a wavelength meter device that comprises
a polarization controller is positioned at least along a path of a first optical beam received from an optical source, said first optical beam having an uncontrolled state of polarization, and the polarization controller producing a second optical beam with a state of polarization that does not change substantially during a time interval necessary for a readout of optical frequency of the first optical beam; and
a plurality of optical components positioned at least partially in a path of the second optical beam, each optical component generates a signal relative to at least a portion of optical frequencies of the first optical beam in response to passage of a portion of the second optical beam through at least a portion of each optical component of the plurality of optical components; and
each signal is periodic with an optical frequency of the first optical beam, and phase shifts between each signal vary over multiple periods of each signal; and the wavelength meter device determines an optical frequency of the first optical beam with a uncertainty of less than the period of each signal; and
a coupler coupled to the wavelength meter device and configured to couple a readout of optical frequency of the optical source and control optical frequency.

56. A wavelength meter device, comprising:
a polarization scrambler positioned at least partially in a first optical beam, said first optical beam having an uncontrolled state of polarization, the polarization scrambler producing a second optical beam with a state of polarization that changes substantially, such that a plurality of states of polarization are produced during the time interval necessary for measurement of optical frequency of the first optical beam; and
a plurality of optical components each positioned at least partially in a path of the second optical beam, each optical component generating a signal relative to at least a portion of optical frequencies of the first optical beam in response to passage of a portion of the second optical beam through at least a portion of each optical component of the plurality of optical components; and
wherein each signal is periodic with an optical frequency of the first optical beam, and phase shifts between each signal vary over multiple periods of each signal; and the wavelength meter device determines an optical frequency of the first optical beam with a uncertainty of less than the period of each signal.

57. The device of claim 56 wherein the signals from the plurality of optical components determine an optical frequency.

58. A wavelength locking device that controls the optical frequency of an optical source, comprising:
a wavelength meter device that comprises
a polarization scrambler positioned at least partially in a first optical beam received from the optical source, said first optical beam having an uncontrolled state of polarization, the polarization scrambler producing a second optical beam with a state of polarization that changes substantially, such that a plurality of states of polarization are produced during the time interval necessary for readout of optical frequency of the first optical beam; and
a plurality of optical components each positioned at least partially in a path of the second optical beam, each optical component generating a signal relative to at least a portion of optical frequencies of the first optical beam in response to passage of a portion of the second optical beam through at least a portion of each optical component of the plurality of optical components; and
each signal is periodic with an optical frequency of the first optical beam, and phase shifts between each signal vary over multiple periods of each signal; and the wavelength meter device determines an optical frequency of the first optical beam with a uncertainty of less than the period of each signal; and
a coupler coupled to the wavelength meter device and configured to couple a readout of optical frequency of the optical source and control optical frequency.

59. A wavelength meter device, comprising:
a tunable optical filter element, positioned at least partially in a first optical beam, that generates a second optical beam; and
a plurality of optical components each positioned at least partially in a path of a first optical beam, each optical component generating a signal relative to at least a portion of optical frequencies of the first optical beam in response to passage of a portion of the first optical beam through at least a portion of each optical component of the plurality of optical components; and
wherein each signal is periodic with an optical frequency of the first optical beam, and phase shifts between each signal vary over multiple periods of each signal; and the wavelength meter device determines an optical frequency of the first optical beam with a uncertainty of less than the period of each signal.

60. The device of claim 59 wherein the signals from the plurality of optical components determine more than one optical frequency.

61. The device of claim 59 wherein one of the optical components is an optical power detector that generates a signal relative to at least a portion of the optical power of the first optical beam in response to the passage of a portion of the first optical beam through at least a portion of the optical power detector.

62. The device of claim 61 wherein the signals from the plurality of optical components determines the optical power spectrum of the first optical beam, comprising more that one optical frequency and the optical power in a bandwidth around the optical frequencies.

63. A wavelength locking device that controls the optical frequency of optical sources, comprising:
a wavelength meter device that comprises
a tunable optical filter element, positioned at least partially in a first optical beam received from an optical source, that generates a second optical beam; and
a plurality of optical components each positioned at least partially in the second optical beam received from an optical source, each optical component generating a signal relative to at least a portion of optical frequencies of the second optical beam in response to passage of a portion of the second optical beam through at least a portion of each optical component of the plurality of optical components; and
each signal is periodic with an optical frequency of the second optical beam, and phase shifts between each signal vary over multiple periods of each signal; and the wavelength meter device determines optical frequencies with a uncertainty of less than the period of each signal; and
a coupler coupled to the wavelength meter device and configured to couple a readout of optical frequencies of the optical sources and control optical frequencies.

64. The device of claim 59, wherein a polarization scrambler is positioned at least partially in an optical beam prior to the plurality of optical components, said optical beam having uncontrolled states of polarization, the polarization scrambler producing an optical beam with states of polarization that change substantially, such that a plurality of states of polarization are produced, during the measurement of optical wavelengths.

65. The device of claim 64 wherein the signals from the plurality of optical components determine more than one optical frequency.

66. The device of claim 64 wherein one of the optical components comprising the wavelength meter device is an optical power sensor that generates a signal relative to at least a portion of the optical power of the first optical beam in response to the passage of a portion of the first optical beam through at least a portion of the optical power sensor.

67. The device of claim 66 wherein the signals from the plurality of optical components determines the optical power spectrum of the first optical beam, comprising more that one optical frequency and the optical power in a bandwidth around the optical frequencies.

68. A wavelength locking device that controls the optical frequency of an optical source, comprising:
a wavelength meter device comprised of a polarization scrambler positioned in a first optical beam, the first optical beam comprising uncontrolled states of polarization and received from an optical source, generating a second optical beam with states of polarization that change substantially, such that a plurality of states of polarization are produced during the measurement of optical frequencies; and
a tunable optical filter element arranged in the second optical beam, generating a third optical beam; and
a plurality of optical components each positioned at least partially in the third optical beam received from an optical source, each optical component generating a signal relative to at least a portion of optical frequencies of the third optical beam in response to passage of a portion of the third optical beam through at least a portion of each optical component of the plurality of optical components; and each signal is periodic with an optical frequency of the third optical beam, and phase shifts between each signal vary over multiple periods of each signal; and the wavelength meter device determines the optical frequency with a uncertainty of less than the period of each signals; and
a coupler coupled to the wavelength meter device and configured to couple a readout of optical frequency of the optical source and control optical frequency.

69. A wavelength meter device, comprising:
a optical power detector positioned at least partially in a first optical beam that generates a signal relative to at least a portion of the optical power of the first optical beam in response to the passage of a portion of the first optical beam through at least a portion of the optical power detector; and
a plurality of optical components each positioned at least partially in a path of a first optical beam, each optical component generating a signal relative to at least a portion of optical frequencies of the first optical beam in response to passage of a portion of the first optical beam through at least a portion of each optical component of the plurality of optical components; and
wherein each signal is periodic with an optical frequency of the first optical beam, and phase shifts between each signal vary over multiple periods of each signal; and the wavelength meter device determines optical frequency with a uncertainty of less than the period of each signal.

70. The device of claim 69 wherein the signals from the plurality of optical components determine an optical frequency.

71. The device of claim 69 wherein each of the plurality of optical components comprises:
an interferometric optical element that generates an interferometric optical element beam relative to a frequency of a portion of the first optical beam; and
an optical power detector that generates a signal in proportion to the optical power of the interferometric optical element beam.

72. The device of claim 71 wherein the optical power detectors comprise photodiodes.

73. The device of claim 71 wherein the optical power detectors comprise an array of photodiodes.

74. The device of claim 71 wherein the optical power detectors comprise a photodiode that includes separate signal producing regions.

75. The device of claim 71, wherein each optical power detector that generates a signal in proportion to the optical power of the interferometric optical element beam comprises an optical integrating sphere and photo detector.

76. The device of claim 75 wherein the optical integrating sphere comprises a substantially hollow cavity.

77. The device of claim 75 wherein the optical integrating sphere comprises a substantially solid cavity.

78. The device of claim 71 wherein the interferometric optical components are etalons.

79. The device of claim 78 wherein the optical power detectors comprise photodiodes.

80. The device of claim 78 wherein the optical power detectors comprise an array of photodiodes.

81. The device of claim 78 wherein the optical power detectors comprise a photodiode that includes separate signal producing regions.

82. The device of claim 78, wherein each optical power detector that generates a signal in proportion to the optical power of the interferometric optical element beam comprises an optical integrating sphere and photo detector.

83. The device of claim 82 wherein the optical integrating sphere comprises a substantially hollow cavity.

84. The device of claim 82 wherein the optical integrating sphere comprises a substantially solid cavity.

85. The device of claim 78 wherein optical beam paths comprise optical elements coupled without adhesive bonding.

86. The device of claim 85 wherein optical beam paths comprise optical elements coupled with optical contacting of surfaces.

87. The device of claim 78 wherein each etalon has an optical transmission characterized by finesse, the finesse of each etalon greater than or equal to about 2.

88. The device of claim 87 wherein said device operates from a minimum optical wavelength to a maximum optical wavelength, the lengths of each etalon differ from each other by odd multiples of substantially one-sixteenth of the wavelength of the input optical beam that is the average of the minimum and maximum optical wavelengths.

89. The device of claim 88 wherein the smallest difference between etalon lengths is substantially equal.

90. The device of claim 89 wherein the signals from the plurality of optical components determine an optical frequency.

91. A wavelength locking device that controls the optical frequency of an optical source, comprising:
a wavelength meter device comprised of a plurality of optical components each positioned at least partially in a first optical beam received from an optical source; and
at least one of the optical components of the wavelength meter device is an optical power detector that generates a signal relative to at least a portion of the optical power of the first optical beam in response to passage of a portion of the first optical beam through at least a portion of the optical power sensor; and
each remaining optical component comprises an etalon and an optical power detector, each etalon generating an etalon optical beam relative to at least a portion of optical frequencies of the first optical beam in response to passage of a portion of the first optical beam through a portion of each etalon; and
each optical power detector generates signal in proportion to the optical power of the etalon optical beam; and
each etalon has an optical transmission characterized by finesse, the finesse of each etalon greater than or equal to about 2; and, the wavelength meter device operating from a minimum optical wavelength to a maximum optical wavelength, the lengths of each etalon differ from each other by odd multiples of substantially one-sixteenth of the wavelength of the input optical beam that is the average of the minimum and maximum optical wavelengths; and the smallest difference between etalon lengths is substantially equal; and
each signal is periodic with an optical frequency of the first optical beam, and phase shifts between each signal vary over multiple periods of each signal; and the wavelength meter determines an optical frequency of the first optical beam with a uncertainty less than the period of any of the plurality of signals; and
a coupler coupled to the wavelength meter device and configured to couple a readout of optical frequency of the optical source and control optical frequency.

92. The device of claim 87 in which the etalons comprise partially reflective optical elements separated by a distance determined by a spacer with air between the elements.

93. The device of claim 92 wherein the spacer is composed of a material of low thermal expansion coefficient.

94. A wavelength meter comprising:
an optical power detector positioned at least partially in a first optical beam, the optical power detector generating a signal relative to at least a portion of the optical power of the first optical beam in response to passage of a portion of the first optical beam through at least a portion of the optical power detector; and
a plurality of air-spaced etalons formed from two optical elements positioned in a path of a first optical beam, one element comprising a first partially-reflective surface, and a second element comprising a second surface on which a plurality of segments are formed of thin film layers of substantially different thicknesses and substantially identical or substantially different compositions, the two surfaces separated by a spacer; and
each segment generating a segment optical beam relative to at least a portion of optical frequencies of the first optical beam in response to passage of a portion of the first optical beam through a portion of each segment; and
optical power detectors generating signal in proportion to the optical power of each segment optical beam; and
wherein each signal is periodic with an optical frequency of the first optical beam, and phase shifts between each signal varies over multiple periods of each signal; and the wavelength meter device determines an optical frequency of the first optical beam with a uncertainty of less than the period of each signal.

95. The device of claim 94, wherein the device operates from a minimum optical wavelength to a maximum optical wavelength, the lengths of each etalon differ from each other by odd multiples of substantially one-sixteenth of the wavelength of the input optical beam that is the average of the minimum and maximum optical wavelengths.

96. The device of claim 95 wherein the smallest difference between etalon lengths is substantially equal.

97. The device of claim 96 wherein the optical power detectors comprise photodiodes.

98. The device of claim 96 wherein the optical power detectors comprise an array of photodiodes.

99. The device of claim 96 wherein the optical power detectors comprise a photodiode that includes separate signal producing regions.

100. The device of claim 96 wherein the signals from the plurality of optical components determine an optical frequency.

101. The device of claim 94, comprising at least 3 air-spaced etalons formed from two surfaces, one surface comprising a monolithic beam splitter on which about a continuous ⅔ of the surface is coated with a thin film layer and about a continuous ⅓ is uncoated, and a second surface comprising an optically transparent substrate on which about a continuous ⅓ of the surface is coated with a thin film layer, and about a continuous ⅔ of the surface is uncoated, the layers formed of the same or identical coating procedures, the two surfaces oriented so that 3 air spaces are formed, each different from the other by one or two identical thicknesses of thin film, the two surfaces separated by a spacer.

102. The device of claim 92, wherein said device operates from a minimum optical wavelength to a maximum optical wavelength, the lengths of each etalon differ from each other by odd multiples of substantially one-sixteenth of the wavelength of the input optical beam that is the average of the minimum and maximum optical wavelengths.

103. The device of claim 102 wherein the smallest difference between etalon lengths is substantially equal.

104. The device of claim 103 wherein the optical power detectors comprise photodiodes.

105. The device of claim 103 wherein the optical power detectors comprise an array of photodiodes.

106. The device of claim 103 wherein the optical power detectors comprise a photodiode that includes separate signal producing regions.

107. The device of claim 103 wherein the signals from the plurality of optical components determine an optical frequency.

108. A wavelength locking device that controls the optical frequency of an optical source, comprising:
a wavelength meter device comprised of a plurality of optical components each positioned at least partially in a first optical beam received from an optical source; and
at least one of the optical components of the wavelength meter device is an optical power detector that generates a signal relative to at least a portion of the optical power of the first optical beam in response to passage of a portion of the first optical beam through at least a portion of the optical power sensor; and
each remaining optical component of the wavelength meter device comprises an etalon and an optical power detector, each etalon comprising partially reflective optical elements separated by a distance determined by a spacer that generates an etalon optical beam relative to at least a portion of optical frequencies of the first optical beam in response to passage of a portion of the first optical beam through a portion of each etalon; and
each optical power detector generates a signal in proportion to the optical power of the etalon optical beam,
each etalon has an optical transmission characterized by finesse, the finesse of each etalon greater than or equal to about 2; and, the wavelength meter device operates from a minimum optical wavelength to a maximum optical wavelength, the lengths of each etalon differ from each other by odd multiples of substantially one-sixteenth of the wavelength of the input optical beam that is the average of the minimum and maximum optical wavelengths; and the smallest difference between etalon lengths is substantially equal; and
each signal is periodic with an optical frequency of the first optical beam, and phase shifts between each signal vary over multiple periods of each signal; and the wavelength meter device determines an optical frequency of the first optical beam with a uncertainty of less than the period of each signal; and
a coupler coupled to the wavelength meter device and configured to couple a readout of optical frequency of the optical source and control optical frequency.

109. A wavelength meter of claim 87 wherein each etalon comprises a solid material that transmits light, the end surfaces of each etalon prepared substantially parallel to each other and about normal to the direction of optical transmission, the free spectral range of each etalon substantially not equal to any other etalon comprising the wavelength meter.

110. The device of claim 109 wherein said device operates from a minimum optical wavelength to a maximum optical wavelength, the lengths of each etalon differ from each other by odd multiples of substantially one-sixteenth of the wavelength of the input optical beam that is the average of the minimum and maximum optical wavelengths.

111. The device of claim 110 wherein the smallest difference between etalon lengths is substantially equal.

112. The device of claim 111 wherein the optical power detectors comprise photodiodes.

113. The device of claim 111 wherein the optical power detectors comprise an array of photodiodes.

114. The device of claim 111 wherein the optical power detectors comprise a photodiode that includes separate signal producing regions.

115. The device of claim 111 wherein the signals from the plurality of optical components determine an optical frequency.

116. A wavelength locking device that controls the optical frequency of an optical source, comprising:
a wavelength meter device that includes a plurality of optical components each positioned at least partially in a first optical beam received from an optical source; and
at least one of the optical components of the wavelength meter device is an optical power detector that generates a signal relative to at least a portion of the optical power of the first optical beam in response to passage of a portion of the first optical beam through at least a portion of the optical power detector; and
each remaining optical component of the wavelength meter device comprises a solid etalon and optical power detector, each solid etalon comprising a solid material that transmits light and has end surfaces prepared substantially parallel to each other and about normal to the direction of optical transmission that generates a solid etalon optical beam relative to at least a portion of optical frequencies of the first optical beam in response to passage of a portion of the first optical beam through a portion of each solid etalon; and
each optical power detector generates a signal in proportion to the optical power of each solid etalon optical beam; and
each solid etalon has an optical transmission characterized by finesse, the finesse of each solid etalon greater than or equal to about 2; and wherein the wavelength meter device operates from a minimum optical wavelength to a maximum optical wavelength, the lengths of each solid etalon differ from each other by odd multiples of substantially one-sixteenth of the wavelength of the input optical beam that is the average of the minimum and maximum optical wavelengths; and the smallest difference between solid etalon lengths is substantially equal; and
each signal is periodic with an optical frequency of the first optical beam, and phase shifts between each signal varies over multiple periods of each signal; and the wavelength meter device determines an optical frequency of the first optical beam with a uncertainty of less than the period of each signal; and
a coupler coupled to the wavelength meter device and configured to couple a readout of optical frequency of the optical source and control optical frequency.

117. The device of claim 69, wherein each of the plurality of remaining optical components comprises an electro-optical element that generates a signal relative to a frequency of a portion of the first optical beam.

118. The device of claim 117 wherein the signals from the plurality of optical components determine an optical frequency.

119. A wavelength locking device that controls the optical frequency of an optical source, comprising:
a wavelength meter device that includes a plurality of optical components each positioned at least partially in a first optical beam received from an optical source; and
at least one of the optical components of the wavelength meter device is an optical power detector that generates a signal relative to at least a portion of the optical power of the first optical beam in response to passage of a portion of the first optical beam through at least a portion of the optical power detector; and
each remaining optical component of the wavelength meter device generate signal relative to at least a portion of optical frequencies of the first optical beam in response to passage of a portion of the first optical beam through a portion of each optical component; and
each signal is periodic with an optical frequency of the first optical beam, and phase shifts between each signal vary over multiple periods of each signal; and the wavelength meter device determines an optical frequency with a uncertainty of less than the period of each signal; and
a coupler coupled to the wavelength meter device and configured to couple a readout of optical frequency of the optical source and control optical frequency.
